(19) United States
(12) Patent Application Publication
(10) Pub. No.: US 2026/0019944 A1
(43) Pub. Date: Jan. 15, 2026

(54) CROSS-LINK POWER SAVE DESIGN FOR AP AND NON-AP STATIONS

(71) Applicants: SONY GROUP CORPORATION, Tokyo (JP); SONY CORPORATION OF AMERICA, New York, NY (US)

(72) Inventors: Qing Xia, San Jose, CA (US); Salvatore Talarico, Los Gatos, CA (US)

(73) Assignees: SONY GROUP CORPORATION, Tokyo (JP); SONY CORPORATION OF AMERICA, New York, NY (US)

(21) Appl. No.: 19/238,927

(22) Filed: Jun. 16, 2025

Related U.S. Application Data
(60) Provisional application No. 63/670,617, filed on Jul. 12, 2024.

(51) Int. Cl. H04W 52/02; H04W 84/12

(52) U.S. Cl. CPC H04W 52/0216; H04W 52/028; H04W 84/12

(57) ABSTRACT

Cross link signaling in a WiFi protocol which supports cross link power management, having Automatic Power Save Delivery (APSD) on the AP side, and which includes unscheduled (U)-APSD and scheduled (S)-APSD, over one or multiple links or sub-channels. An explicit TWT for a broadcast TWT provides the flexibility of having a broadcast TWT SP between two subsequent negotiated broadcast TWT SPs. Individual/broadcast TWTs can be suspended and resumed for all member STAs toward improving efficiency of AP power saving. Additional elements and benefits are described.

### CROSS-REFERENCE TO RELATED APPLICATIONS

This application claims priority to, and the benefit of, U.S. provisional patent application Ser. No. 63/670,617 filed on Jul. 12, 2024, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to WiFi network communications, and more particularly to Power Save (PS) mechanism which operates for both Access Point (AP) and non-AP stations.

### 2. Background Discussion

Current Wi-Fi designs provide scheduled Power Save (PS) mechanisms based on Target Wake Time (TWT) or Target Beacon Transmission Time (TBTT), yet are directed for use on non-AP STAs, and not for the AP, especially for a single link AP device. This limits the efficiency of PS in regard to AP MLDs.

Accordingly, a need exists for a WiFi protocol/apparatus, which supports cross link signaling on the AP side of the communications. The present disclosure fulfills that need and provides additional benefits over existing systems.

### BRIEF SUMMARY

Cross link signaling is described which supports cross link power management, having Automatic Power Save Delivery (APSD) on the AP side, and which includes unscheduled (U)-APSD and scheduled (S)-APSD, over one or multiple links or sub-channels. An explicit TWT for a broadcast TWT, is described which provides the flexibility of having a broadcast TWT SP between two subsequent negotiated broadcast TWT SPs. The apparatus under this protocol can suspend and resume individual/broadcast TWTs for all member STAs, which improves the efficiency of AP power saving. New TTLM rules or TTLM features are described, including dynamic TTLM designed to capture the needs for PS over multiple links and for cross link power management.

The cross-link signal can be sent through the active link(s) to perform operations on at least one specific link(s) to wakeup the dozed AP and/or STAs; put AP and/or STA(s) to doze mode; and Suspend and resume TWT agreements/schedules for certain or all TWT member STAs.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a block diagram of communication station hardware, according to at least one embodiment of the present disclosure.

FIG. 2 is a block diagram of Multi-Link Device (MLD) hardware according to at least one embodiment of the present disclosure.

FIG. 3 is a high level architecture for AP MLDs having multiple affiliated APs according to at least one embodiment of the present disclosure.

FIG. 4 is a network topology diagram according to at least one embodiment of the present disclosure.

FIG. 5 is a diagram showing cross-link power management between non-AP MLDs and an AP MLD, according to at least one embodiment of the present disclosure.

FIG. 6 is a communication diagram showing an example of cross-link power management, according to at least one embodiment of the present disclosure.

FIG. 7A and FIG. 7B is a communication diagram showing enhanced S-APSD based PS on the AP side, according to at least one embodiment of the present disclosure.

FIG. 8A and FIG. 8B illustrate 510 an example of enhanced U-APSD based PS on the AP side according to at least one embodiment of the present disclosure.

FIG. 9 is a communication diagram showing waking up a dozing AP outside of the implicit Individual or Broadcast (I/B) TWT SPs to start operating in the wake-up service period through cross-link power management, according to at least one embodiment of the present disclosure.

FIG. 10A and FIG. 10B is a communication diagram of resuming an individual TWT through cross-link transition, according to at least one embodiment of the present disclosure.

FIG. 11A through FIG. 11C is a communication diagram resuming an individual TWT corresponding to specific TWT member(s) through Cross-link transition on one active link, according to at least one embodiment of the present disclosure.

FIG. 12A through FIG. 12C is a communication diagram resuming individual TWT corresponding to all TWT members through a Cross-link transition on one active link, according to at least one embodiment of the present disclosure.

FIG. 13A through FIG. 13C is a communication diagram resuming a broadcast TWT corresponding to all TWT member through Cross-link transition on one active link, according to at least one embodiment of the present disclosure.

FIG. 14A through FIG. 14C is a communication diagram of flexibility in explicit TWT and implicit TWT, according to at least one embodiment of the present disclosure.

FIG. 15A and FIG. 15B is a communication diagram of soliciting the next TWT through Cross-link transition on one active link, according to at least one embodiment of the present disclosure.

FIG. 16A and FIG. 16B is a communication diagram of Dynamic TTLM, according to at least one embodiment of the present disclosure.

FIG. 17 is a data field diagram of an enhanced TWT Information field format, according to at least one embodiment of the present disclosure.

FIG. 18 is a data field diagram of a Request Type field format, according to at least one embodiment of the present disclosure.

### DETAILED DESCRIPTION

### 1. Introduction

In previous Wi-Fi designs, scheduled Power Save (PS) mechanisms, such as Target Wake Time (TWT)-based or Target Beacon Transmission Time (TBTT)-based, are mainly only designed for non-AP STAs, and not for the AP, especially for a single link AP device. This is because putting the single link AP into sleep mode or inactive mode could easily create numerous issues, such as loss of network synchronization, failure of neighbor discovery, (re)association, relaying and so on.

In the Wi-Fi protocol IEEE 802.11be, Extra High Throughput (EHT) APs are multiple link devices (MLD), more specifically, each AP Multiple-Link Device (MLD) has multiple APs affiliated with it which are operating on multiple links, the combination of which support cross-link operations, such as association, transmission and reception. However, there is no cross-link Power Management (PM) designed in 802.11be. The risk of putting one or multiple AP(s) affiliated with one AP MLD into sleep mode or the inactive mode, while keeping other AP(s) affiliating with the same AP MLD in an awake mode or active mode should be much less than that for single link AP.

Besides the risk for the scheduled PS on the AP side would be lower than that with the dynamic PS. In this context, the scheduled PS mechanism for AP MLD and/or the associated non-AP MLD is useful to further provide PS benefits for the MLD in 802.11bn.

In current the current 802.11bn specification, the non-AP STA that is in PS mode can turn off its receiver and thus would not receive any frames, while the AP will temporarily buffer all frames destined to this non-AP STA that is in PS-mode. The AP can announce the presence of buffered frames to non-AP STAs at each TBTT through sending Beacon frames, which contain Traffic Indication Messages (TIMs). The non-AP STA should wake up at each TBTT and listen to beacons. If a beacon indicates the existence of Buffered Units (BUs) for the non-AP STA, the non-AP STA will transmit a polling frame (e.g., QoS Null or PS-Poll) to elicit receiving the BUs from the AP.

The non-AP STA which is in the PS-mode can awake at any time to transmit UL PPDU. The non-AP STA can use the Power Management (PM) subfield in the Frame Control field of a frame to indicate whether it is in active mode or PS mode, thus informing the (causing) the AP to buffer PPDUs destinated to this non-AP STA. The non-AP STA shall remain in current PM mode until it receives from AP an Ack frame. The current PS-mode is only being applied on non-AP STA side of communications. Thus, a design for PS-mode on the AP side would be beneficial to provide improved tradeoffs between power saving and throughput.

In current specification Draft P802.11be_D6.0 and Draft P802.11REVme_D5.0, U-APSD performs like a polling scheme and could be working with WWM-PS (Wi-Fi Multimedia PS), for a non-AP STA to send UL polling/trigger frame to elicits AP to release BU to it, with the requirement that the released BU should be with the Access Category (AC), which is the same as the delivery-enabled AC of the polling/trigger frame. AP sets the End Of Service Period (EOSP) subfield in the last Downlink (DL) frame to a first state (e.g., 1) to indicate the end of the service period. The non-AP STA could then return back into PS-mode. Similarly, the current Unscheduled Automatic Power Save Delivery (U-APSD) is only applied on non-AP STA side. Thus, the design for U-APSD on AP side is needed.

In current specification Draft P802.11be_D6.0 and Draft P802.11REVme_D5.0, S-APSD is designed for AP to deliver DL Physical layer Protocol Data Units (PPDUs) with specific AC to non-AP STAs in PS-mode automatically during planned time intervals. It would be beneficial if the AP and non-AP STAs in PS-mode could negotiated planned time intervals; whereby there is a need for an S-APSD on the AP side as well.

The current specification Draft P802.11be_D6.0 and Draft P802.11REVme_D5.0 has indicated that the AP and non-AP STA that may be in doze state outside the indicated TWT SPs by setting the Responder PM Mode bit in the Control field of the TWT response equal to a first state (e.g., 1). Regardless of whether the Responder PM Mode subfield is set to either state, the AP unavailability both inside and outside of the TWT Service Period (SP) is affected by any advertised broadcast TWT element with Broadcast TWT ID subfield equal to a second state (e.g., 0) and with Responder PM Mode subfield equal to a first state (e.g., 1). However, the PS operation during TWT SP in the current 802.11be specification is only defined for non-AP STA side. Thus, it would be beneficial to extend the design for operation on the AP side as well. The present disclosure primarily focuses on the scheduled PS mechanisms which are designed for both UHR AP and UHR non-AP devices.

### 2. Current Power Saving Mechanisms

Different PS mechanisms are defined in pre 11bn specifications and are briefly summarized as follows.

Power management modes: The non-AP STA can be in one of two power management modes which include an active mode and a Power Saving (PS) mode. For the PS mode, the STA receives and transmits frames at any time if the STA is in awake state. A non-High Efficiently (non-HE) STA remains in the awake state. An HE STA remains in the awake state unless the STA is unavailable. A STA that is unavailable is not capable of receiving PPDUs.

For the PS mode: The STA enters the awake state to receive or transmit frames. The STA remains in the dozing state otherwise. A STA in the PS mode can be in one of two power states: Awake—in which the STA is fully powered, and Doze (Dozing) in which the STA is not able to transmit or receive (802.11ba) non-WUR PPDUs and consumes very low power.

A STA operating in the active mode shall have its receiver activated continuously, (802.11ax) unless the STA is allowed to be temporarily unavailable through the opportunistic power save mechanism or through the intra-PPDU power save mechanism or during TWT SP; such STAs do not need to interpret the TIM elements in Beacon frames.

Non-AP STA PS: To change power management modes, a STA informs the AP by completing a successful frame exchange that is initiated by the STA. This frame exchange sequence shall include a Management frame, Extension frame or Data frame from the STA, and an Ack or a BlockAck frame from the AP. The Power Management subfield(s) in the Frame Control field of the frame(s) sent by the STA in this exchange indicates the power management mode that the STA shall adopt upon successful completion of the frame exchange sequence, except where the Power Management subfield is reserved. A non-AP STA shall not change power management mode using a frame exchange sequence that does not receive an Ack or BlockAck frame from the AP, or using a BlockAckReq frame.

Wireless Network Management (WNM) mode: enables an extended power save mode for non-AP STAs in which a non-AP STA need not listen for every Delivery Traffic Indication Message (DTIM) Beacon frame and need not perform Group Transmit Key (GTK), Integrity Group Transmit Key (IGTK), or Beacon Integrity Group Transmit Key (BIGTK) updates. A STA may use both WNM sleep mode and PS mode simultaneously.

Automatic Power Save Delivery (APSD): A STA in APSD PS mode sends frames with the Power Management (PM) subfield set to a first state (e.g., 1) in the Frame Control field, causing the AP to buffer Data. Quality of Service (QoS) STAs use the PM subfield in the Frame Control field of a frame to indicate whether it is in active or PS mode. As APSD is a mechanism for the delivery of Bus to power saving STAs, the frames transmitted by a STA in PS mode that is using APSD have the PM subfield in the Frame Control field set to a first state (e.g., 1), thereby causing buffering to take place at the AP. APSD defines two delivery mechanisms, unscheduled APSD (U-APSD) and scheduled APSD (S-APSD).

If there is no U-APSD SP in progress, the unscheduled SP begins when the AP receives a trigger frame from a STA, which is a QoS Data or QoS Null frame using an AC the STA has configured to be trigger-enabled. An unscheduled SP ends after the AP has attempted to transmit at least one BU using a delivery-enabled AC and destined for the STA, but no more than the number indicated in the Max SP Length field of the QoS Capability element in the (Re)Association Request frame of the STA if the field has a nonzero value. The last frame sent during the SP has the EOSP subfield set to a first state (e.g., 1).

A scheduled SP starts at fixed intervals of time and begins at the scheduled wakeup time that corresponds to the Service Interval (SI) and the service start time, indicated in the Schedule element sent in response to a Traffic Specification (TSPEC) or Groupcast with Retries (GCR) request scheme.

APSD shall be used only to deliver individually addressed BUs and GCR-SP BUs to a STA.

A STA using APSD shall operate as follows to receive a BU from the AP: If a scheduled SP has been set up, the STA wakes up at its scheduled start time. If the STA is initiating an unscheduled SP, the STA wakes up and transmits a trigger frame to the AP. The STA shall remain awake until it receives a QoS Data frame or QoS Null frame addressed to it, with the EOSP subfield equal to a first state (e.g., 1). The STA may send additional PS-Poll frames if the More Data subfield is set to a first state (e.g., 1) in a downlink individually addressed MAC Protocol Data Unit (MPDU) (where MAC stands for the Medium Access Control layer) containing all or part of a BU that does not use a delivery-enabled AC. The STA may send additional trigger frames if the More Data subfield is set to a first state (e.g., 1) in a downlink (DL) individually addressed MPDU containing all or part of a BU that uses a delivery-enabled AC.

Non-APSD (automatic power save delivery) PS mode: In a BSS operating under the DCF or EDCA, upon determining that a BU is currently buffered in the AP, a STA operating in the normal (non-APSD) PS mode transmits a (NDP) PS-Poll frame to the AP, which responds with the corresponding buffered BU immediately, or acknowledges the (NDP) PS-Poll frame and responds with the corresponding BU at a later time.

Power Saving Multi-Poll (PSMP): An AP transmits a PSMP frame containing a schedule only for STAs that are awake. A STA with an established PSMP session shall be awake at the start of the SP of the session and shall remain awake until the end of the SP, unless it is permitted to return to sleep.

The AP may signal the end of the SP for all awake associated PSMP-capable STAs by setting the More PSMP field to a second state (e.g., 0) or by sending a CF-End frame instead of the next PSMP frame.

Opportunistic Power Saving (OPS): The objective is to allow OPS non-AP STAs to be unavailable or to be in dozing state so that they can save power for a defined period. OPS has two modes: aperiodic and periodic.

In the aperiodic mode, an OPS AP sends an OPS frame or a Fast Initial Link Setup (FILS) Discovery frame at any time to provide the scheduling information for all OPS non-AP STAs for the OPS period. Based on this information, the OPS non-AP STAs that are in active mode may be unavailable during the OPS period, and the OPS non-AP STAs that are in PS mode may be in the dozing state during the OPS period. The TIM element is encoded specifically in order to identify which STAs are not scheduled during the OPS period.

In the periodic mode, an OPS AP splits (divides) a beacon interval into several periodic broadcast TWT SPs and provides, at the beginning of each SP, the scheduling information for all OPS non-AP STAs. Based on this information, the OPS non-AP STAs that are in active mode may be unavailable until the next TWT SP, and the OPS non-AP STAs that are in PS mode may be in the dozing state until the next TWT SP. To enable periodic opportunistic power saving, an OPS AP shall include a TWT element in beacons to set a periodic Broadcast TWT SP with the following information: the Broadcast TWT Recommendation field set to a unique value indicating periodic OPS, (e.g., a value of 3) and the Broadcast TWT ID subfield set to zero (0).

Intra-PPDU power save for non-AP HE STAs: Intra-PPDU power saving is the power save mechanism for an HE STA to enter the dozing state, or otherwise become unavailable, until the end of a received PPDU that is identified as an intra-BSS PPDU. The STA can enter the dozing state if it is in PS mode and can become unavailable if it is in active mode. A non-AP HE STA that is in intra-PPDU power save mode and has entered a dozing state or has become unavailable shall continue to operate its NAV timers and to consider the medium busy and shall transition to the awake state at the end of the PPDU. A non-AP HE STA that is in the intra-PPDU power save mode may discard an inter-BSS PPDU until the end of the PPDU.

Spatial Multiplexing (SM) PS: The SM power save feature allows a non-AP HT STA or a non-AP and non-PCP EDMG STA in an infrastructure BSS or PBSS to operate with only one active receive chain for a significant portion of time. The STA needs to transmit an SM power save frame to enter the SM power save mode. In dynamic SM power save mode, the non-AP STA uses a single RF chain for listening, and switches to the multiple receive chain mode when it receives a frame addressed to it. The frame exchange sequence shall start with a single-spatial stream with an individually addressed frame that is not a Trigger frame, and requires an immediate response that is addressed to the STA in dynamic SM power save mode. The STA shall be capable of receiving a PPDU that is sent using more than one spatial stream with a SIFS after the end of the PPDU it sends as the immediate response. The STA may switch back to the single receive chain mode immediately after the end of the frame exchange sequence.

Enhanced Mode Spatial Multiplexing with Low-Rank (EMLSR): The EMLSR operation allows a non-AP MLD with multiple receive chains to listen on one or more EMLSR links when the corresponding non-AP STA(s) affiliated with the non-AP MLD is (are) in the awake state, for an initial Control frame sent by an AP affiliated with an AP MLD in a non-HT (duplicate) PPDU and then participate in frame exchanges on the link on which the initial Control frame was received.

Enhanced Multi-Link Multi-Radio (EMLMR): The enhanced multi-link multi-radio (EMLMR) operation allows a non-AP MLD with multiple radios on multiple links to listen a set of links as defined below for an initial frame sent by an AP affiliated with an AP MLD, followed by frame exchanges that satisfy the Modulation and Coding Scheme (MCS) and Number of Spatial Streams (NSS) capabilities in the EMLMR mode on the link on which the initial frame was received. In this case the initial frame is transmitted in a PPDU whose NSS satisfies the capabilities of the receiving STA. A non-AP MLD which supports the EMLMR Option shall indicate the number of spatial streams NSS that it supports for reception and transmission on any EMLMR link after responding to the initial frame in the EMLMR Supported MCS and NSS Set subfield of the EML Control field of the EML Operating Mode Notification frame.

If a TWT scheduling AP has advertised a TWT element that carries one or more Broadcast TWT Parameter Set fields with a Broadcast TWT ID subfield equal to 0 and a Responder PM Mode subfield in the Control field of the TWT Element equal to 1, then:

If the NDP Paging Indicator/Unavailability Mode subfield of the TWT Element is set to 0, the AP may be unavailable outside of these broadcast TWT SPs, except within any other TWT SP that is set up with the AP or advertised by the AP.

If the NDP Paging Indicator/Unavailability Mode subfield of the TWT Element is set to 1, then the AP may be unavailable outside of these broadcast TWT SPs, even if that time falls within any other TWT SP that is set up with the AP or advertised by the AP.

An AP that is unavailable is not capable of receiving PPDUs.

### 3. Problem Statement

In 802.11bn, the TGbn (Ambient Power Communications) working group has passed the motion to define a cross-link power save signaling mechanism, which allows a non-AP MLD to indicate to its associated AP MLD that supports the mechanism, in a frame sent on one enabled link, the power management mode for one or more of its affiliated non-AP STAs. However, this is proposed to achieve cross-link PM from the non-AP MLD side. The present disclosure proposes that a cross-link PM for the AP MLD should also be designed.

There is no existing scheduled PS mechanism designed for the AP MLD and non-AP MLD supporting cross-link power save signaling.

Besides, there are still potential issues to be considered for cross-link PS for AP MLD and non-AP MLDs, such as conflict arising from TID-to-Link mapping.

Other than the cross-link power save signaling, cross BSS power saving for the Basic Service Set (BSS) within the same multiple BSS-Identification (BSSID) parameter set should also be designed to capture the power saving of the guest network as managed by the host network.

In addition, the power management attained with Automatic Power Save Delivery (APSD) in the current specification is only designed for the non-AP side and should be extended to the AP side, which should be used in unscheduled (U)-APSD and scheduled (S)-APSD, over one or multiple links or sub-channels.

The AP may enter into the dozing state outside of TWT SPs by setting the Responder PM bit of TWT element to a first state (e.g., 1). A potential issue caused by having no service outside the TWT SP for a duration on the order of tens of milliseconds arises and may require more flexible TWT SP on-off schedules. However, in the current specification the explicit (flexible) TWT operation is only supported in an individual TWT. Although the TWT Information frame could be applied to both individual TWT and broadcast TWT to suspend and resume TWT agreement/schedules, which provide some level of flexibility of TWT schedule. However, the use of a TWT information frame could capture the flexibility of skipping one or more TWT SPs spatially when the All TWT subfield in the TWT information field is set to a first state (e.g., 1) and especially for the broadcast TWT, when there is a need to provide flexibility, such as resuming a TWT SP between two subsequent TWT SPs, the TWT information frame has limited capability to achieve this goal, in this case, it may still need to extend the explicit TWT to cover a broadcast TWT.

When the flexibility provided by the application of TWT information frame is considered, the current suspension and resumption is limited by either one specific TWT agreement/schedule with setting the All TWT subfield to a second state (e.g., 0) and a non-zero Next TWT subfield in the TWT Information element or multiple TWT agreement/schedule for the same (set of) TWT member STA(s) with setting All TWT subfield to a first state (e.g., 1) and non-zero Next TWT subfield in the TWT Information element or buffer a non-zero Next TWT subfield to be transmitted in another TWT Information frame. This means the suspension and resumption is applied to one or more TWT agreements or schedules between the AP and the same TWT member non-AP STA(s). This requires the AP to suspend Individual TWT SPs and Broadcast TWT SPs with all non-AP STAs one by one (for individual TWT) or group by group (for broadcast TWT) if the AP needs to suspend the TWT SPs for all non-AP STAs, which is inefficient for the AP to have to perform to achieve power saving.

Besides, both the explicit TWT operation and the TWT Information frame is preferred for use to decide the Next TWT within the current TWT SP, otherwise, the negotiation devices cannot move into the dozing state until they have exchanged the non-zero Next TWT information, which would be an inefficient power saving. In addition, the potential issue of meeting random transmission needs outside of the TWT SP is still an open issue.

Different TID-To-Link Mapping (TTLM) may cause different impacts on AP MLD and non-AP MLD power saving through cross link management. New TTLM rules or TTLM features, such as dynamic TTLM should be designed to capture the needs for PS over multiple links and for cross link power management.

### 4. Solution Statement

This disclosure proposes cross link signaling to support cross link power management, having Automatic Power Save Delivery (APSD) on the AP side, which includes unscheduled (U)-APSD and scheduled (S)-APSD, over one or multiple links or sub-channels.

This disclosure describes an explicit TWT for a broadcast TWT, which provides the flexibility of having a broadcast TWT SP between two subsequent negotiated broadcast TWT SPs.

This disclosure describes a design to suspend and resume individual/broadcast TWT for all member STAs, which improves the efficiency of AP power saving.

This disclosure also describes new TTLM rules or TTLM features, including dynamic TTLM designed to capture the needs for PS over multiple links and for cross link power management.

### 5. Communication Hardware Embodiments

### 5.1. Communication Station (STA and MLD) Hardware

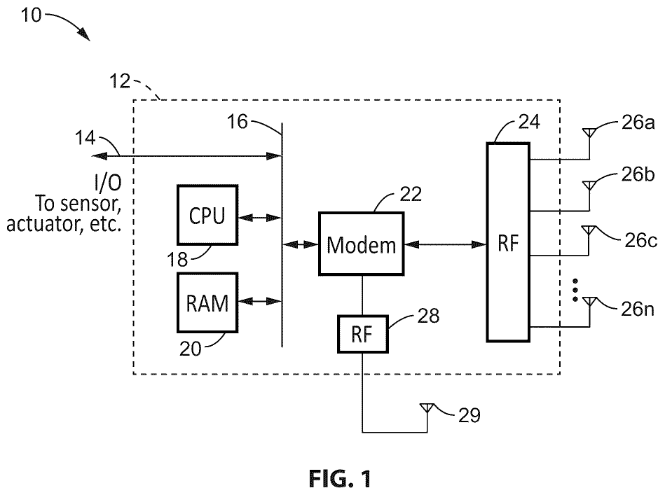

FIG. 1 illustrates an example embodiment 10 of STA hardware configured for executing the protocol of the present disclosure. An external 1/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an Access Point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

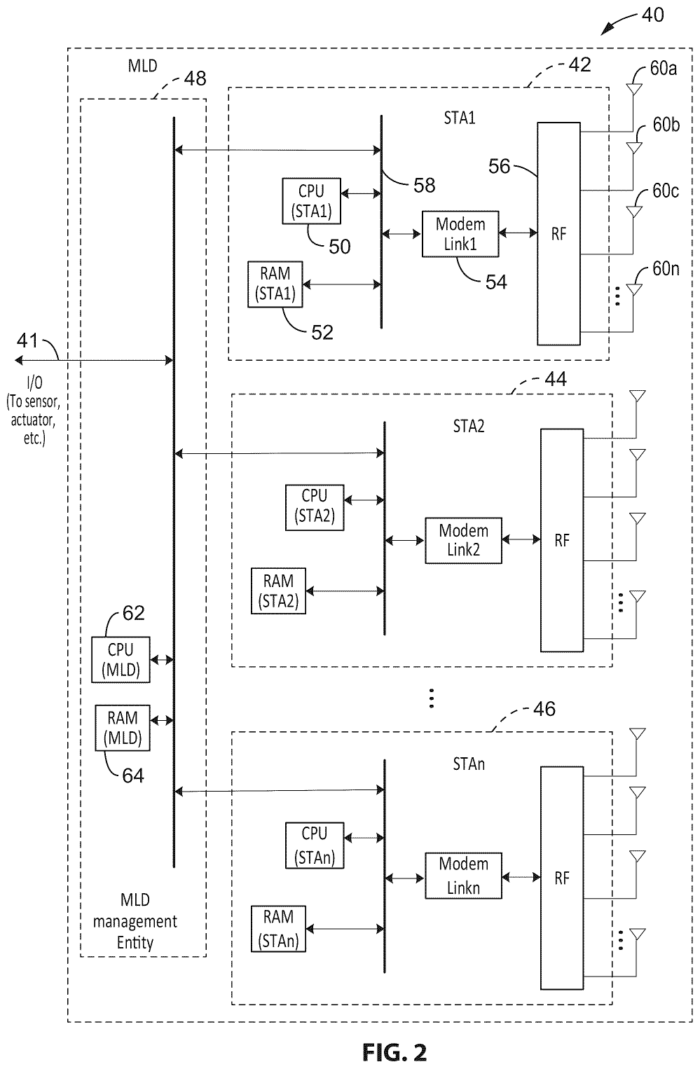

FIG. 2 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHz), basic link set (2.4 GHz and 6 GHz).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 5.2. Backhaul Architecture for AP MLDs

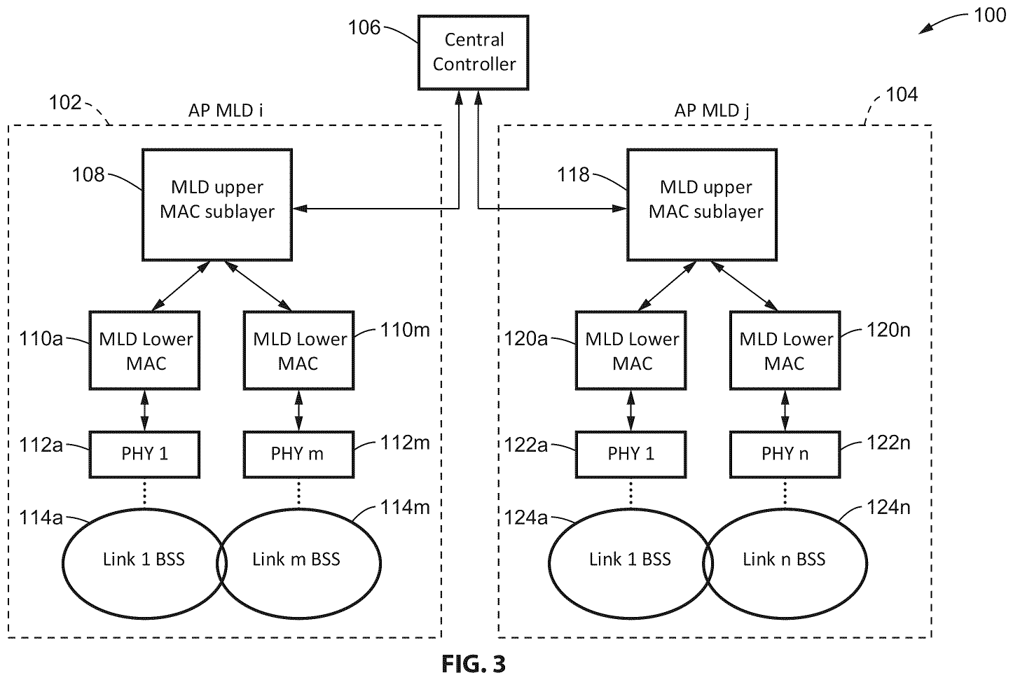

FIG. 3 illustrates an example embodiment 100 of a high level architecture for AP MLDs having multiple affiliated APs (e.g., 102, 104) connected to a central controller 106. The proposed enhancements provided in this disclosure may have a backhaul connection between cooperating APs. The backhaul architecture has one central controller connected with multiple AP MLDs through wired and/or wireless backhauls and each AP MLD 102, 104 includes the MLD upper MAC sublayer 108, 118, and one or more MLD lower MAC sublayers, one for each link 110a-110m, 120a-120n. In the 802.11be specification, the MLD upper MAC sublayer performs functionalities that are common across all links, and each MLD lower MAC sublayer performs functions that are local to each link. For example, some link management related functions, such as TID-to-Link mapping and Link Merging, are placed in the MLD upper MAC sublayer. In 802.11bn, certain functionalities originally in the MLD upper MAC sublayer as specified in 802.11be may be suitably placed in the central controller, so as to be able to enhance seamless roaming with limited or no interruptions of service. The present disclosure considers link management functionalities placed in the central controller and/or the MLD upper MAC sublayers. It should be noted that the figure also depicts the connections to the Physical layer (PHY) 112a-112m, 122a-122n, and then down to the Link layers 114a-114m, 124a-124n.

### 6. Example Network Topologies

It should be appreciated that the following topology is provided for the purpose of exemplifying network operations, and is not to be interpreted as describing limitations on the topologies within which the teachings of the present disclosure can operate.

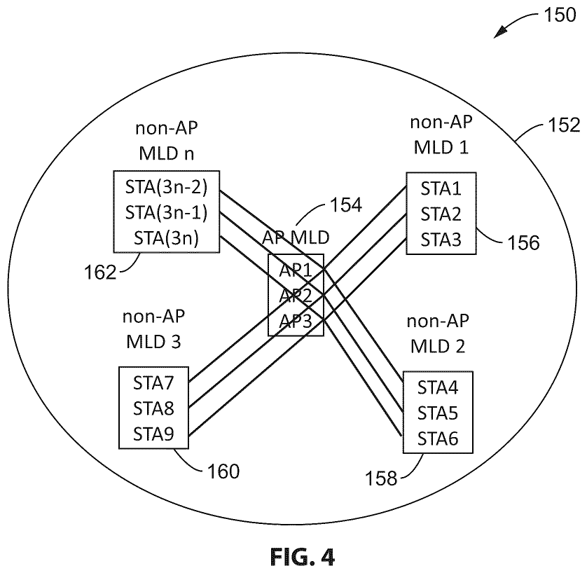

FIG. 4 illustrates a network topology 150 in which the AP MLD 154 shown with range 152 is associated with ‘n’ number of non-AP MLDs. In this example there are shown three APs (e.g., AP1, AP2 and AP3) affiliated with the AP MLD and each non-AP MLD 156, 158, 160 162 are exemplified with three non-AP STAs affiliated with it. In these examples, the AP MLD and the non-AP MLDs have established link setup over three links, which in these examples are for 2.4 GHz, 5 GHz and 6 GHz links.

### 7. Cross-Link Power Management

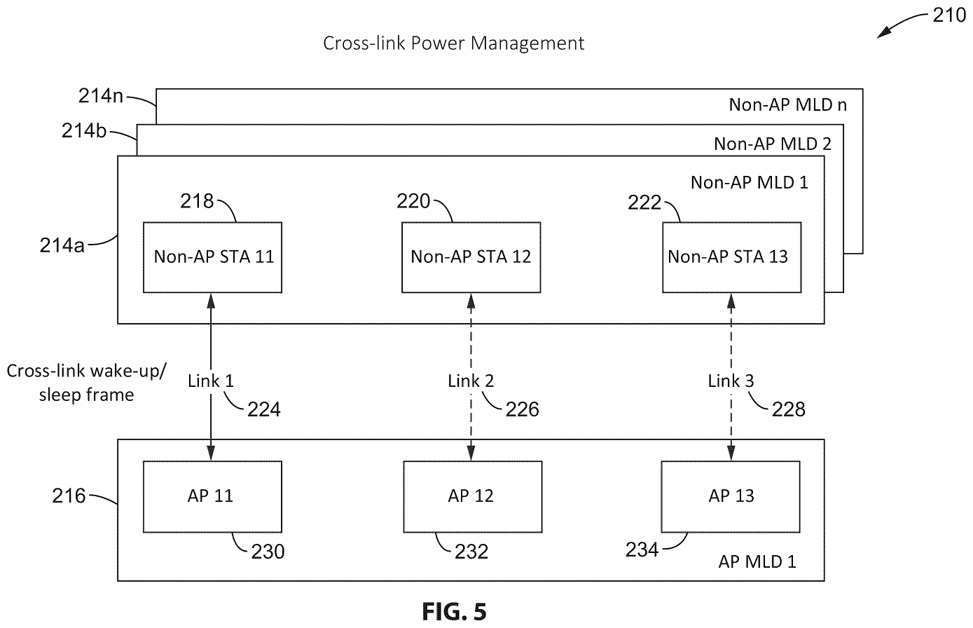

FIG. 5 illustrates an example of Cross-Link Power Management 210 according to at least one embodiment of the present disclosure. In the figure is shown multiple non-AP MLDs 214a, 214b through to 214n, which are connected through multiple links, exemplified as links Link1 224, Link2 226, and Link3 228, to an AP MLD 216 having AP11 230, AP12 232 and AP13 234.

In at least a first type of Cross-Link Power Management (Cross-Link PM) operation, one or more of the AP(s), for example AP12 and AP13 affiliated with the same AP MLD goes into a doze (dozing) state on a portion of the available Multiple-Link-Operation (MLO) links, such as Link2 and Link3, while the other AP(s) affiliating with the same AP MLD, e.g., AP11, maintain an active state on the other link(s), for example Link1 in the figure.

Instead of exchanging frames over each link separately to change the PM mode on that link, the Cross-Link PM mode directions on the changes to sleep mode are carried by the cross-link sleep frame. For example, AP11 can broadcast a cross-link sleep frame to indicate that both AP12 and AP13 are to go into dozing mode at the scheduled time for a certain duration.

If the associated non-AP MLDs have Buffered Units (BU) to transmit to AP MLD1 216 over Link2 226 and Link3 228, when AP MLD1 is in doze state, then one of the non-AP MLDs can send a cross-link wake up frame to AP11 230 over Link1 224. AP11 230 receives the cross-link wake up frame over Link1 and awakens the other AP(s) affiliated with the same AP MLD1 as indicated in the cross-link wake up frame.

In at least a second type of Cross-Link PM operation, one or more of the non-AP STA(s), such as non-AP STA12 220 and non-AP STA13 222 in FIG. 5, which are affiliated with the same non-AP MLD go into a dozing state on a portion of the available MLO links, such as Link2 226 and Link3 228, while the other non-AP STA(s) affiliated with the same non-AP MLD, for instance non-AP STA11 218, remain in an active state on the other link(s), which would be Link1 224 in this example.

Thus, instead of exchanging frames over each link separately (independently) to change the PM mode on that link, the cross-link PM mode allows changing the status of sleep mode as carried by a cross-link sleep frame. For example, non-AP STA11 218 could transmit a cross-link sleep frame to direct non-AP STA12 220 and non-AP STA13 222, respectively, to go into a dozing mode at the scheduled time and for a selected duration.

When the associated AP MLD has Buffered Units (BU) to transmit to the non-AP MLD1 216 over Link2 226 and Link3 228, on which the non-AP STA12 220 and non-AP STA13 222 affiliated with non-AP MLD1 are in the dozing state, the AP MLD sends a cross-link wake up frame to non-AP STA11 218 over Link1 224. Non-AP STA11 upon receiving the cross-link wake up frame over Link1 224 wakes up the non-AP STA(s) affiliated with the same non-AP MLD 1 as indicated in the cross-link wake up frame.

In at least one embodiment, the link that is used to transmit cross-link power management frames (including the cross-link wake-up frame and cross-link sleep frame) should have its Transmit Identifier (TID) mapped to its operating link, and/or should be able to receive from all affiliated non-AP MLDs and legacy non-AP STAs on its operating link.

In at least one embodiment, an AP affiliated with the AP MLD should not enter into the dozing state if the operating link of the AP has legacy (pre-Extra High Throughput (EHT)) STAs operating on it.

In at least one embodiment, the AP or non-AP STA affiliating with an AP MLD or a non-AP MLD, respectively, should not enter into the dozing state if it has Uplink (UL) and/or Downlink (DL) TID(s) that are only mapped to a single link, which is its operating link, unless the AP or non-AP STA can assure that the other AP(s) or non-AP STA(s) that are affiliated with the same AP MLD or non-AP MLD, is in an active mode and can receive the cross-link wake-up frames indicating the need for a wake-up to receive the UL and/or DL TID(s) traffic which is only mapped to that single link.

In at least one embodiment, the cross-link wake-up/sleep frame can be a cross-link variant of a Control frame, such as a cross-link Trigger frame, a cross-link PS-Poll frame.

In at least one embodiment, the cross-link wake-up/sleep frame can wake up or direct to put into sleep more than one of the APs or non-AP STAs that are affiliated with the same AP MLD or non-AP MLD, in response to the AP or the non-AP STA receiving the cross-link wake-up or transmitting the cross-link sleep frame. In at least one mode the cross-link wake-up/sleep frame can use the identical link ID used to indicate on which link the PS mode should be changed for the affiliated AP or non-AP STA.

In at least one embodiment, the cross-link wake-up/sleep frame can indicate the independent wake up or sleep time for each AP, or non-AP STA, that it needs to wake up or put into sleep mode. The timing here can be described in any desired manner, such as in regard to an absolute time, such as TSF, or using a time offset.

In at least one embodiment, the cross-link sleep frame can indicate the independent sleep duration for each AP or non-AP STA that it needs to put into sleep mode. After this duration, the AP or non-AP STA returns to active mode.

In at least one embodiment, the cross-link wake-up/sleep frame can indicate the active or dozing modes by including information on a PM bit per-link. If the PM bit in the cross-link sleep frame is set to a first state (e.g., 1) it indicates the AP or non-AP STA as indicated in the corresponding link ID, and affiliated with the same MLD as the sender AP or non-AP STA, should enter into dozing mode, and whether or not it will be receiving a response after sending the cross-link sleep frame. If the PM bit in the cross-link wake-up frame is set to a second state (e.g., 0), as indicated by the AP or non-AP STA in the corresponding link ID and affiliated with the same MLD as the receiver AP or non-AP STA, should go into active mode, after transmitting a response of the cross-link wake-up frame.

In at least one embodiment, the cross-link wake-up frame can indicate whether there is buffered UL PPDU for AP or DL PPDU for a specific non-AP STA, as identified by the Association Identification (AID). Together with this, the detail on Buffer Units (BUs), such as queue size for a specific Access Category (AC) or for a specific Traffic Identifier (TID) and other elements of information may be included, for instance the overall Queue size.

In at least one embodiment, the cross-link signal can also carry the Next TWT field, All TWT fields, or All member TWT fields for suspending and resuming TWT SPs on another link.

In at least one embodiment, the cross-link signal can also carry the request fields to solicit the resumed TWT SP for a specific TWT member or TWT ID on one/more other link(s), indicated by specific link ID(s).

In at least one embodiment, the cross-link signal can specify the TID for the requesting traffic on a different link, which may be the specific TID mapped to that link. The specific TID may or may not be mapped on the link used to transmit the cross-link signal.

In at least one embodiment, there can arise cross-link information exchange delay, if this overhead is excessive, it may diminish the benefit from scheduled multi-link power management. Thus, it is preferably then to change power management mode separately on each link (e.g., per-link) instead of using the cross-link signaling.

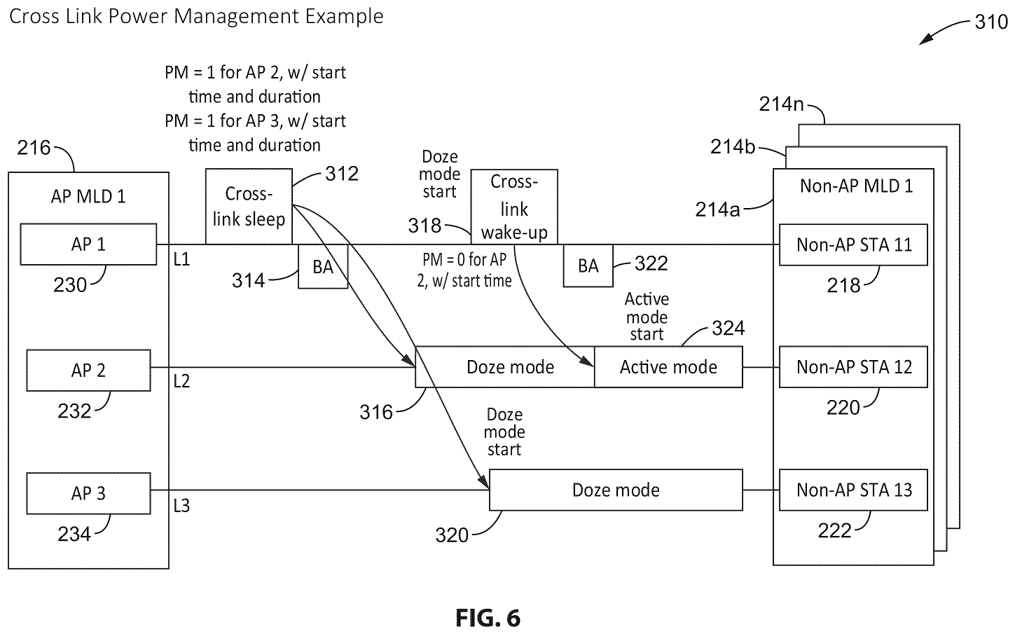

FIG. 6 illustrates an example communication showing cross-link power management 310 where an AP MLD (e.g., AP MLD1 216) is associated with multiple non-AP MLDs (e.g. non-AP MLD1 214a, non-AP MLD2 214b, through to non-AP MLDn 214n). There are multiple established links (e.g., three in this example) between AP MLD1 216 and the associated non-AP STAs, where the links are identified as L1, L2 and L3 respectively, over which AP1, AP2 and AP3 are respectively operating. All of these APs are operating at the beginning of this scenario in an active mode or awake state in PS mode.

Then, AP1 sends cross-link signaling 312 on L1 with the purpose of indicating that AP2 and AP3, and thus links L2 and L3, will be entering the dozing state and includes information about the start time and the duration for AP2 and AP3, respectively, will enter this dozing period. Non-AP STA11 218 receives the instruction and responds back with a Block Ack (BA) frame, and communicates this information to non-AP STA12 220 and non-AP STA13 222.

Thus, the cross-link signal sent by AP1 is received over L1 by the non-AP STA(s) which acknowledges reception of the cross-link signal. AP2 and AP3 enter doze mode 316, 320 at the corresponding doze start time on L2 and L3, respectively.

Before the dozing modes of AP2 and AP3 ends, AP1 sends another cross-link signal 318 indicating a change to the PS mode of AP2, specifically that it is to be awakened or enter the active mode at a specific time. Again, the non-AP STA associated with AP1 on L1 receives this cross-link signal and can send a response 322 to acknowledge the reception of the cross-link information. AP2 then should wakeup 324 at the specified time point on L2.

### 8. Power Saving on the AP Side

The current AP power management in the current specification Draft P802.11be_D6.0 and Draft P802.11REVme_D5.0 describes AP power management procedure for an AP:

An AP shall not be in the dozing state for a duration of time that exceeds the value of the dot11MaxAwayDuration. The AP shall set dot11MaxAwayDuration to the lowest value obtained from the Max Away Duration (MAD) field that is contained in the most recently received MAD elements from any of its associated STAs.

Irrespective of the Power Management mode and Power States, an AP shall maintain the synchronization of the network by generating beacons.

A STA that receives a frame transmitted by an AP should conclude that the AP is in active mode if the PM Mode subfield is set to a second state (e.g., 0).

An AP that has previously sent a frame to one STA, or a group of STAs with PM bit equal to 0, shall send a frame with PM bit equal to 1 to the same set of STAs before changing its operation mode to Power Save mode.

A STA that receives a frame transmitted by an AP should conclude that the AP is in Power Save mode if the PM Mode subfield is set to a first state (e.g., 1).

However, the power management with automatic power save delivery (APSD) in the current specification Draft P802.11be_D6.0 and Draft P802.11REVme_D5.0 is only designed for the non-AP side and should be extended to use on AP side for use in unscheduled (U)-APSD and scheduled (S)-APSD, over one or multiple links or sub-channels.

In at least one embodiment, the APSD designed for the AP side is used as a mechanism for the delivery of BUs from non-AP STAs to the AP in PS mode, and the frames transmitted by an AP in PS mode that is using APSD have the Power Management subfield in the Frame Control field set to a first state (e.g., 1), thereby causing buffering to take place at the non-AP STA(s).

In at least one embodiment, the AP should consider the QoS parameters of the associated non-AP STAs when determining the power saving patterns.

In at least one embodiment, the AP shall not be in the dozing state for a duration that exceeds the value of the dot11MaxAwayDuration during a beacon interval or short beacon interval.

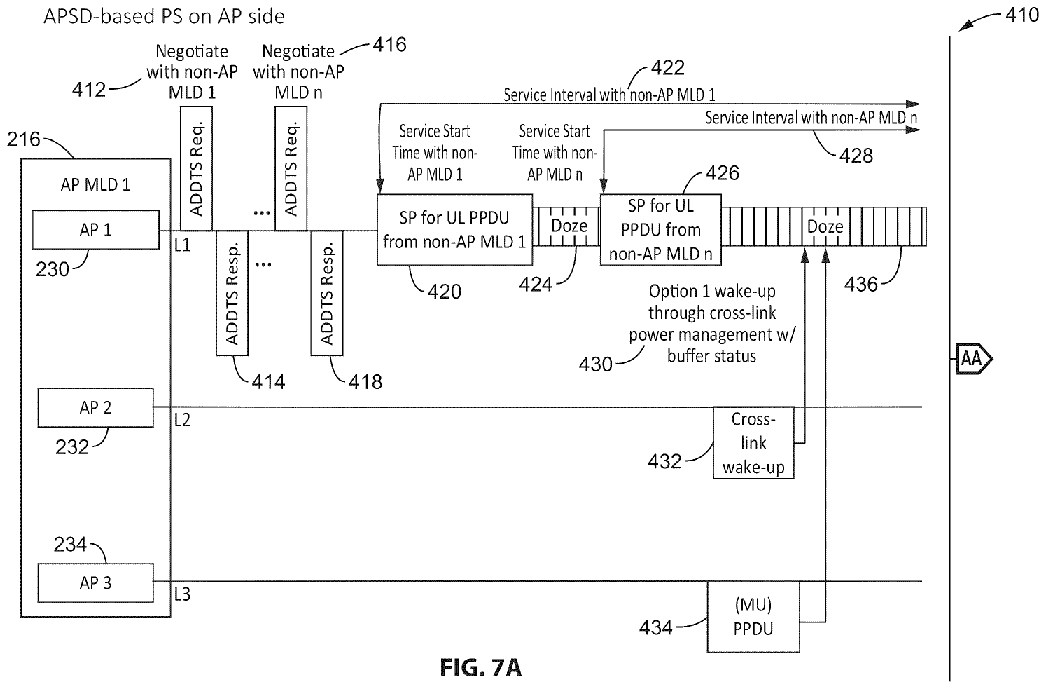

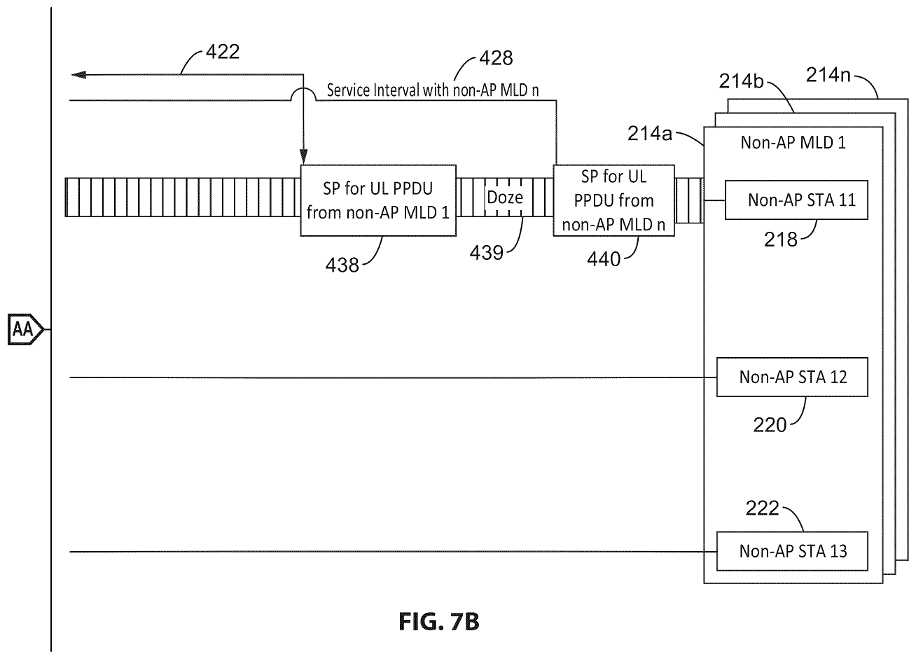

FIG. 7A and FIG. 7B illustrates an example 410 of enhanced S-APSD based PS on AP side where an AP MLD (e.g., AP MLD1 216) is associated with multiple non-AP MLDs 214a, 214b through to 214n. There are multiple (e.g., 3) established links between AP MLD 1 and its associated non-AP STAs, identified as L1, L2 and L3 respectively. AP1 230, AP2 232 and AP3 234 are operating on L1, L2 and L3, respectively and are in active mode or awake state in PS mode at the beginning of this scenario.

First, AP1 negotiates with the non-AP STA affiliated with non-AP MLD1 on L1 through the exchange of ADDTS Request frame 412 and ADDTS Response frames 414. The negotiation sets up a S-APSD service period (SP) 422, with an indicated SP start time, duration and SP interval.

Similar negotiation is also performed between AP1 and non-AP MLD n, showing negotiation request 416 and response 418 frames. During the corresponding SPs, AP1 wakes up to receive UL PPDUs 420 from non-AP MLD 1 or from non-AP MLD n. AP1 can enter doze state 424 outside of the negotiated SPs. The figure depicts the second SP 428 with an associated UL PPDU 426 from the non-AP MLD, after which AP1 returns to dozing state 436.

While AP1 is in dozing mode on L1, non-AP MLDs can send a cross-link signal to AP2 as a cross-link wake-up 432, and to AP3 as a cross-link MU (PPDU), respectively, to wakeup AP1 on L1. In this example, the cross-link signal is sent to AP2 indicating the buffer status of the non-AP STA.

Another option is when AP1 is in dozing mode on L1, that AP2 and AP3 can obtain buffer status information from the Queue size subfield in the QoS control field of the received PPDU on L2 and L3, respectively. AP2 and AP3 may decide based on this information to wakeup AP1 on L1. In this example, AP3 could wakeup AP1 based on the received Queue size information.

In at least one embodiment, a scheduled SP starts at fixed intervals of a time specified in the Service Interval field in the Schedule element that could be transmitted by AP to non-AP STAs and by non-AP STAs to AP through a frame, such as ADDTS Response frame when the TS is admitted and sent in response to a TSPEC or GCR Request. The Schedule element should carry several fields including but not limited to the Element ID, Length, Scheduling Info, Service Start Time, Service Interval and Specification Interval. Where the Scheduling Info field could carry several subfield including but not limited to Aggregation, TSID, Direction and Reserved. The Service Start Time field indicates the anticipated time when SP starts, which could be a TSF time or an offset time. The Service Interval (SI) field indicates the time between two successive SPs as measured from the start of SPs.

In at least one embodiment, an AP shall send a frame, such as ADDTS Request frame to the non-AP STA with the APSD subfield of the TS Info field in the TSPEC element set to 1.

In at least one embodiment, an AP shall send a frame, such as ADDTS Request frame to the non-AP STA with the APSD and Schedule subfields of the TS Info field in the TSPEC element both set to 1. If the APSD mechanism is supported by the non-AP STA and the non-AP STA accepts the corresponding ADDTS Request frame from the AP, the non-AP STA shall respond to the ADDTS Response frame with a response containing the Schedule element indicating that the requested service can be accommodated by the non-AP STA.

In at least one embodiment, upon reception of the ADDTS Request frame, the non-AP STA shall process the content of the base ADDTS request. If the non-AP STA determines that the base ADDTS request cannot be granted it shall respond without processing the U-APSD Coexistence element. If the non-AP STA determines the base ADDTS request can be granted, it shall process the U-APSD Coexistence element. If the non-AP STA supports transmission of frames during the U-APSD service period for the duration value specified in the U-APSD Coexistence element Interval/Duration field, it shall grant the ADDTS request. Otherwise, it shall deny the ADDTS Request.

In at least one embodiment, if the SI is nonzero, an AP using scheduled SP shall first transition to awake state at the service start time to transmit downlink individually addressed and/or GCR-SP group addressed BUs buffered and/or to receive polls from the non-AP STAs. The AP shall transition to awake state subsequently at a fixed time interval equal to the SI.

In at least one embodiment, an AP could have a mixed PS-Mode with U-APSD and S-APSD coexist.

In at least one embodiment, an AP in PS-mode, e.g., AP1 in FIG. 7B could wakeup from PS-Mode on Link1 to poll for the UL PPDU transmission 438, from the non-AP STA(s) (as described in Section 8.2 U-APSD-based PS on AP side) that either sends a Cross-link wake-up frame in advance on other link(s) with indicating the buffer status for specific AC(s) or specific TID(s) that explicitly indicates the needs for AP1 to wake-up to receive buffered UL PPDUs; or based on the Queue Size subfield together with TID subfield in the QoS control field of the received UL (MU) PPDU(s) on other link(s) that implicitly indicate the need for AP1 to wake-up to receive buffered UL PPDUs; or based on the buffer status report information carried by the BSR frame or the More Data bits in the Frame Control field.

After this first polling 438 the AP1 is shown returning to dozing mode 439, and then after the second interval of dozing, then again polling 440 for a UL PPDU from the non-AP MLD.

In at least one embodiment, the TIDs mapped to the link, on which AP in PS-Mode is operating on, should be a subset of the TIDs that are mapped to the link(s) on which other AP(s) in active mode are affiliated with the same AP MLD. This is because the TID subfield in the QoS Control field indicates the TID of the data. If the TID indicated in the TID subfield in the QoS Control field does not map to the link on which the AP in PS-mode is operating, the AP MLD would not wake up its affiliated AP in PS-mode on the link where the known buffered DATA does not map to that link.

In at least one embodiment, the AP MLD can broadcast the schedule of its PS-mode on a per link basis through using Beacon frames, Probe Responses, or Action frames. The associated non-AP MLD(s), upon receiving this schedule information can doze its affiliated non-AP STA(s) with aligned power saving (SP) in accord with the schedule for the dozed AP on specific link(s).

### 8.2. U-APSD-Based PS on AP Side

In at least one embodiment, if there is no U-APSD SP in progress, the U-APSD SP begins when the AP sends a trigger frame to non-AP STA, which could be a QoS Data or QoS Null frame using AC(s) that the AP has configured to be trigger-enabled. An unscheduled SP ends after the non-AP STA has attempted to transmit at least one BU using a delivery-enabled AC and directed to the AP, yet not exceeding the number indicated in the Max SP Length field of the QoS Capability element of the (Re)Association Response frame of the AP if the field has a nonzero value.

A delivery-enabled AC indicates a quality-of-service (QoS) AP AC or non-AP STA AC where the AP or the non-AP STA is allowed to use Enhanced Distributed Channel Access (EDCA) to deliver traffic from the AC to a QoS non-AP STA or QoS AP in an unscheduled service period (SP) triggered by the non-AP STA or the AP.

Trigger-enabled AC indicates quality-of-service (QoS) non-AP STA AC, or AP AC, where frames of subtype QoS Data and QoS Null from the non-AP STA or the AP that map to the AC trigger of an unscheduled service period (SP) if one is not in progress.

In at least one embodiment, the QoS Info field of the QoS Capability element carried in a (Re)Association Response frame(s) when sent by an AP should also include the Max SP Length field and the individual U-APSD Flag bits for each AC, such as AC_VO U-APSD Flag, AC_VI U-APSD Flag, AC_BK U-APSD Flag and AC_BE U-APSD Flag. When a U-APSD Flag bit is set to a first state (e.g., 1), this indicates that the corresponding AC is both delivery-enabled and trigger-enabled. When all four U-APSD Flag subfields are equal to a first state (e.g., 1) in (Re)Association Response frames, then all of the ACs associated with the AP are trigger-enabled and delivery enabled during (re)association. When all four U-APSD Flag subfields are equal to a second state (e.g., 0) in (Re)Association Response frames, then none of the ACs associated with the AP are trigger-enabled or delivery-enabled during (re)association.

In another embodiment, the AP may designate one or more ACs as trigger-enabled and one or more ACs as delivery-enabled, by sending a request frame, such as ADDTS Request frame per AC to the non-AP STA with the APSD subfield set to a first state (e.g., 1) and the Schedule subfield set to a second state (e.g., 0) in the TS Info field in the TSPEC element.

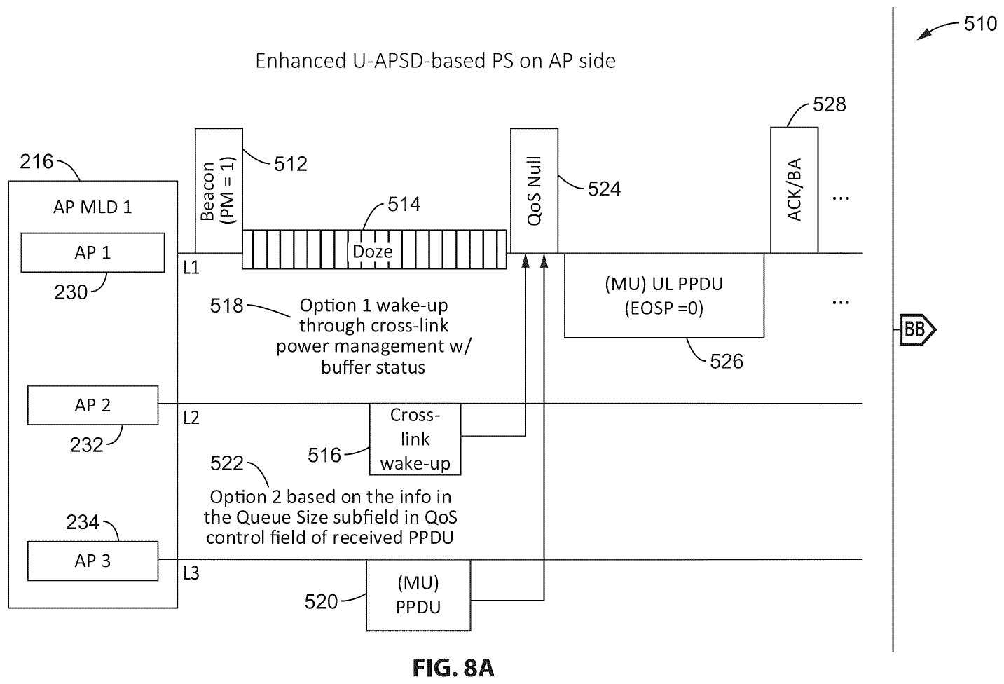

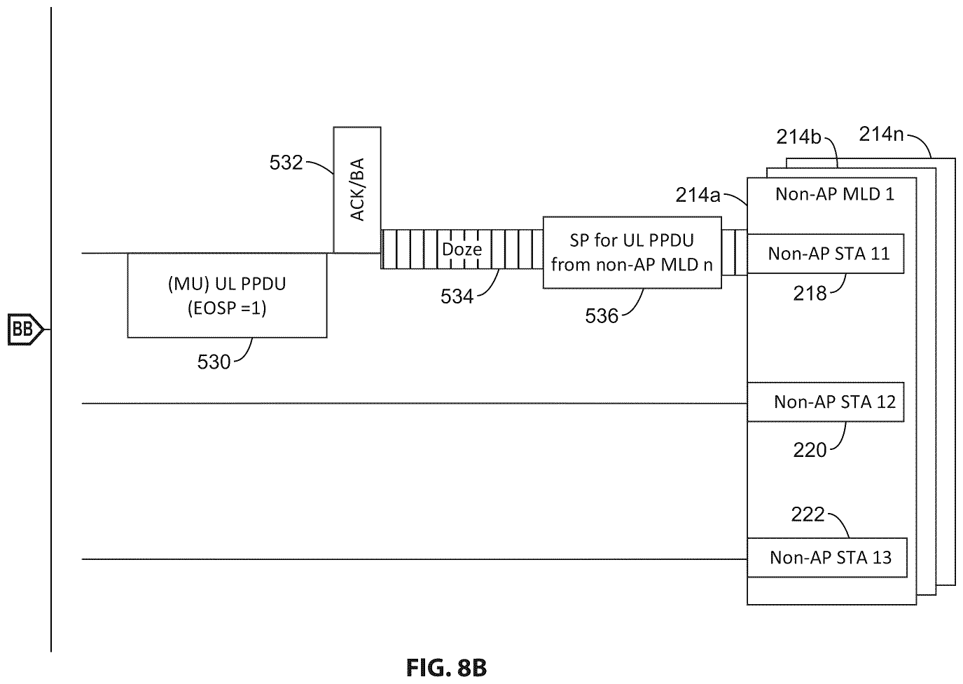

FIG. 8A and FIG. 8B illustrate 510 an example of enhanced U-APSD based PS on the AP side, where an AP MLD (e.g., AP MLD1 216) is associated with multiple non-AP MLDs STA11 218, STA12 220, and STA13 222. There are three established links exemplified between AP MLD 1 and its associated non-AP STAs, identified as L1, L2 and L3 respectively. AP1, AP2 and AP3 are operating on L1, L2 and L3, respectively and are all in active mode or awake state in PS mode.

First, AP1 sends a Beacon frame 512 on L1 with PM value set to a first state (e.g., 1) which indicates AP1 will enter the power saving mode and the associated non-AP STAs which receives this Beacon frame should start buffering UL PPDUs to be transmitted on L1. When AP1 is in doze mode 514 on L1, non-AP MLDs can send cross-link signals 516, 518 to AP2 and AP3 on L2 and L3, respectively, to wakeup AP1 on L1.

In a first option 518 for this example, the cross-link signal 516 is sent to AP2 indicating the buffer status of the non-AP STA. Another option 522 is shown when AP1 is in doze mode on L1, while AP2 and AP3 obtains buffer status information from the Queue size subfield in QoS control filed of the received PPDU 520 on L2 and L3, respectively. AP2 and AP3 may decide based on this information whether or not to wakeup AP1 on L1.

In this example, the AP3 could wakeup AP1 based on the received Queue size information. Later when AP wakes up on L1, AP1 sends a QoS Null frame 524 to announce that it is awake and ready to receive buffered UL PPDUs from the non-AP STAs on L1.

Non-AP STAs on L1 then transmit their UL PPDUs 526, 530 to AP with the EOSP field to indicate if they finished transmitting all buffered PPDUs. With EOSP set to a first state (e.g., 1) indicates they no longer have buffered PPDU to transmit, while EOSP field set to a second state (e.g., 0) indicates they still have buffered PPDU to transmit. AP1 should acknowledge 528, 532 the reception of each (MU) UL PPDU.

AP1 then returns to the dozing mode 534 after acknowledging the most recently received (MU) UL PPDU with EOSP indicating it has no more buffered PPDU to transmit. Together with the U-APSD based SP on L1, the S-APSD based SP 536, as negotiated for non-AP MLD n, is allowed to operate on L1 as well.

In at least one embodiment, the AP in the PS-mode can send the QoS Data or QoS Null frame using AC(s) the AP has configured to be trigger-enabled on Link 1 to elicit the UL PPDU transmission from the non-AP STA(s) that either sends a Cross-link wake-up frame in advance on other link(s) indicating the buffer status for specific AC(s), or specific TID(s) that explicitly indicates the need for AP1 to wake-up to receive buffered UL PPDUs; or based on the Queue Size subfield together with TID subfield in the QoS control field of the received UL (MU) PPDU(s) on other link(s) that implicitly indicate the need for AP1 to wake-up to receive buffered UL PPDUs; or based on the buffer status report information carried by the BSR frame or the More Data bits in the Frame Control field.

In at least one embodiment, the TIDs mapped to the link, on which the AP in PS-Mode is operating on, should be a subset of the TIDs that are mapped to the link(s) on which other AP(s) in active mode are affiliated with on the same AP MLD. This is because the TID subfield in the QoS Control field indicates the TID of the data. If the TID which is indicated in the TID subfield in the QoS Control field does not map to the link on which the AP in PS-mode is operating, then the AP MLD would not wake up its affiliated AP in PS-mode on the link where the known buffered DATA does not map to that link.

In at least one embodiment, an AP can broadcast QoS Data or a QoS Null frame to trigger multiple associated non-AP STAs to send buffered UL (MU) PPDUs to AP.

In at least one embodiment, an AP could return to PS-Mode after acknowledging the most recently received UL PPDU with EOSP subfield set in the QoS control field indicating the final frame per non-AP STA/AID to end an SP.

In at least one embodiment, an AP may enter the dozing state at the end of the U-APSD service period.

In at least one embodiment, an AP can have a mixed PS-Mode with U-APSD and S-APSD coexist.

In at least one embodiment, an AP MLD can broadcast the schedule of its PS-mode per-link through Beacon frames, Association Responses, Probe Responses, Management frames, Control frames, or Action frames. The associated non-AP MLD(s), upon receiving this schedule information can doze its affiliated non-AP STA(s) with aligned power saving SP as that scheduled for the dozed AP on specific link(s).

### 9. TWT-Based Power Saving

In at least one embodiment, the TWT-based power saving should be applied at both AP and non-AP STA sides for both individual TWT and broadcast TWT, or for at least one of them.

In at least one embodiment, the AP and the non-AP STAs can remain awake inside the negotiated TWT SPs. However, in at least one mode, it could be mandated that the AP and the non-AP STAs always enter the dozing state outside of the negotiated TWT SPs.

In another embodiment, the AP and the non-AP STA can still enter the dozing state during negotiated TWT SPs in some cases:

In at least one embodiment, an AP that is a TWT responding STA in an individual TWT, or a TWT scheduling AP in broadcast TWT, that is not in PS mode and that transmits a frame with the Power Management subfield set to a first state (e.g., 1) during a TWT SP shall remain in the awake state until the AdjustedMinimumTWTWakeDuration time has elapsed from the TWT SP start time, or until a TWT SP termination event is detected, or whichever occurs first for that particular TWT SP.

A MAC variable AdjustedMinimumTWTWakeDuration is defined for each TWT of each TWT agreement and has a value equal to the Nominal Minimum TWT Wake Duration minus the elapsed time from the scheduled start of the TWT SP to the actual start of the SP. AdjustedMinimum-TWTWakeDuration could be a single or a multiple of values that can concurrently apply within a TWT.

In at least one embodiment, an AP that is in the PS mode and is in the awake state for a TWT SP may transition to the dozing state after the value AdjustedMinimumTWTWakeDuration time has elapsed from the TWT SP start time even if it has previously transmitted a PS-Poll frame or U-APSD trigger frame and has not yet received the expected frames from the non-AP STA in response. For a trigger-enabled TWT SP, if the value given by AdjustedMinimumTWTWakeDuration time has elapsed from the scheduled TWT SP start time and no UL TB PPDU are received by the AP after a SIFS duration since AP sent the Trigger/ICF frames, the AP may enter the dozing state if no other condition requires the AP to remain awake.

In at least one embodiment, for a TWT SP termination event, such as when the EOSP field is set to indicate no more PPDs, is sent within a TWT SP by an AP in PS mode that is participating in the TWT SP and if the AP knows there are no more UL PPDUs buffered in the associated TWT member non-AP STAs, the AP may transition to the dozing state without waiting for the expiration of the AdjustedMinimumTWTWakeDuration time, even if it has previously transmitted a PS-Poll frame or U-APSD trigger frame and has not yet received the expected frames from the non-AP STA in response.

In at least one embodiment, the AP and/or non-AP STA should be capable of waking up inside and outside the agreed or negotiated TWT SP to finish any buffered unit for re-transmission(s) or when it is expected to receive a retransmission as a consequence of a prior Negative Acknowledgement (NACK) indication. The AP and/or non-AP STA can wakeup based on the expected processing time, which may be known or explicitly indicated, or according to a fixed timeline at which the buffered unit is ready for retransmission. The AP and/or non-AP STA can enter dozing mode outside of the agreed or negotiated TWT SP(s) once successfully delivering the retransmitted buffered unit.

In at least one embodiment, the TWT-based PS is allowed to coexist with other PS mechanisms.

In another embodiment, the AP and/or the non-AP STA could wake up outside the negotiated TWT SPs, during which the AP and/or the non-AP STA is in dozing mode and could be awaken by another AP and/or non-AP STA that is affiliating with the same AP MLD and/or non-AP MLD. In this case, the wakeup signal can be carried by a cross link signal that is transmitted or received on another link.

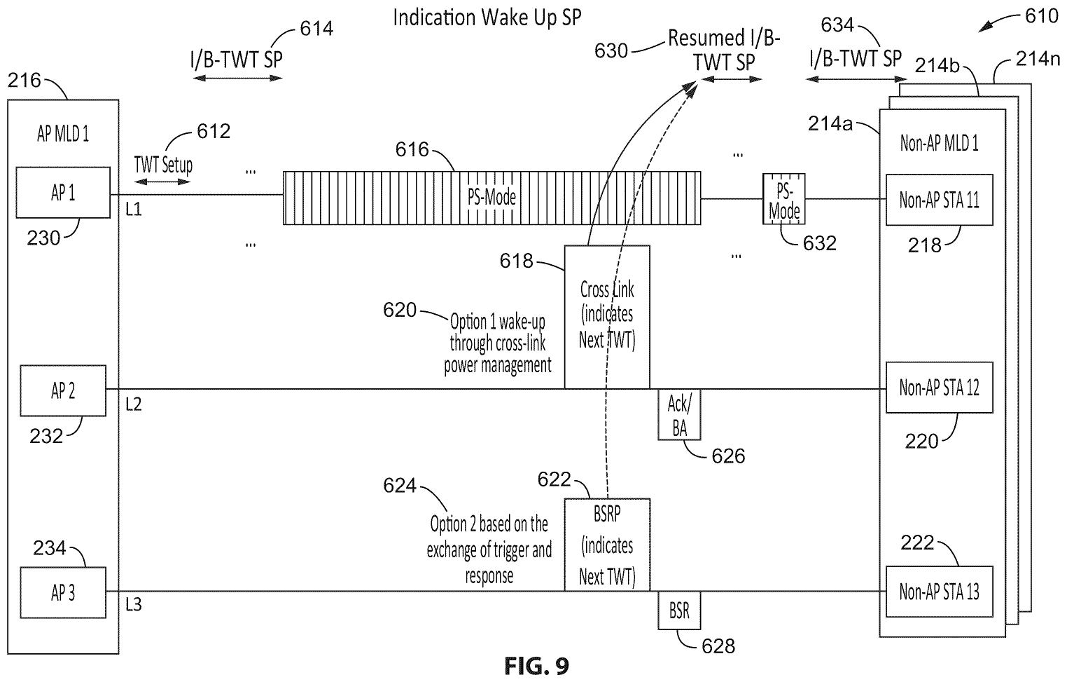

FIG. 9 illustrates an example 610 of waking up a dozing AP outside of the implicit Individual or Broadcast (I/B) TWT SPs to start operating in the wake-up service period through cross-link power management, where an AP MLD 1 is associated with multiple non-AP MLDs. There are multiple established links, exemplified herein as three links, between AP MLD 1 and its associated non-AP STAs, identified as L1, L2 and L3 respectively. AP1, AP2 and AP3 are operating on L1, L2 and L3, respectively and are in active mode or awake state in PS mode.

After the I/B TWT setup procedure 612, AP1 on L1 successfully setup implicit I/B TWT SPs which repeats at a certain certain interval. AP1 should be in active mode or awake state in PS mode during each of the scheduled I/B TWT SPs, while it could enter dozing state outside each scheduled I/B TWT SPs.

When AP1 is in dozing mode 616 on L1, other affiliated APs can send a cross-link signal on other links, to indicate the schedule of the wake-up service period (SP) for AP1, including but not limited to the start time and duration of the SP. Non-AP MLDs received this cross-link signal should make sure their affiliated non-AP STAs on L1 also wake up during the wake-up SP and could respond with acknowledgement.

In a first option 620 the cross-link signal 618 for power management is sent by AP2, and is acknowledged by an Ack/BA 626.

In another option 624 one or more of the APs, such as AP2 and AP3 can carry the schedule of the wake-up service period (SP) for AP1 inside some trigger frames such as Buffer Status Report Poll (BSRP) trigger 622. Non-AP MLDs received this trigger should make certain that their affiliated non-AP STAs on L1 also wakes up during the wake-up SP and responds with a Buffer Status Report (BSR) 638. In this example, the trigger frame carrying the cross link wake-up SP information is sent by AP3.

The figure depicts a resumed I/B TWT SP 630 which may be periodic I/B TWT SPs 634, between which the AP may return to PS mode 632.

### 9.1. TWT Information Frame in Individual and Broadcast TWT

The TWT Information frame is used to suspend and resume Individual and Broadcast (I/B) TWT SPs and can be initiated from both the AP side and non-AP side. However, the current suspension and resumption is limited by either a specific TWT agreement/schedule by setting All TWT subfield.

The All TWT subfield can be set to a first state (e.g., 1) and a non-zero Next TWT subfield in the TWT Information element or buffer indicating a non-zero Next TWT subfield to be transmitted in another TWT Information frame.

Alternatively, the All TWT subfield can be set to a second state (e.g., 0) with non-zero Next TWT subfield specified in the TWT Information element or multiple TWT agreement/schedule for the same (set of) TWT member STAs.

This limitation needs an AP to suspend I/B TWT SPs with all non-AP STAs one by one (for individual TWT) or group by group (for broadcast TWT), and there is provision made to suspend all non-AP STAs at once, which is inefficient for the AP from a power saving perspective. In this section, a new All member TWT subfield in the TWT Information element is created to solve this issue.

In addition, the TWT Information frame is preferred for deciding the Next TWT within the current TWT SP, otherwise, the negotiation devices cannot enter the dozing state until they have exchanged the non-zero Next TWT information for the TWT resumption, which is inefficient, from power saving perspective. In addition, the potential issue of meeting the random transmission needs outside the TWT SP is still an open issue. The cross-link signaling to deal with this issue is proposed in this section.

In at least one embodiment, the TWT Information frame shall have the Response Requested subfield equal to a second state (e.g., 0), with the Next TWT Request subfield equal to a second state (e.g., 0), and one of the following: (a) The Next TWT subfield that is equal to a nonzero value if the frame is transmitted by the AP to a peer STA that has set the Flexible TWT Schedule Support field to a first state (e.g., 1) in the UHR Capabilities element it transmits.

The value of the Next TWT subfield shall be selected from the future target wake times of an individual TWT agreement or broadcast TWT scheduling if the Flexible TWT Schedule Support field in the UHR Capabilities element received from the peer STA is set to a second state (e.g., 0).

The Next TWT subfield may contain any nonzero value if the Flexible TWT Schedule Support field in the UHR Capabilities element received from the peer STA is set to a first state (e.g., 1).

The All TWT subfield is set to a first state (e.g., 1) if the resumption applies to all broadcast TWT schedules followed by the TWT scheduled STA and/or to all individual TWT agreements followed by the TWT responding STA.

The All member TWT subfield is set to a first state (e.g., 1) if the resumption applies to all broadcast TWT schedules followed by the TWT scheduled STA and all other TWT scheduled STAs and/or to all individual TWT agreements followed by the TWT responding STA and all other TWT responding STAs.

A Next TWT subfield that is present if the frame is transmitted by a non-AP STA that has set the Flexible TWT Schedule Support field to a first state (e.g., 1) in the UHR Capabilities element it transmits.

The Next TWT subfield indicates the earliest TWT at which the individual TWT agreement or broadcast TWT schedule is resumed and shall be selected from the future target wake times of that TWT agreement or broadcast TWT schedule if the Flexible TWT Schedule Support field in the UHR Capabilities element received from the peer STA is set to a second state (e.g., 0).

The All TWT subfield is set to a first state (e.g., 1) if the resumption applies to all broadcast TWT schedules followed by the TWT scheduled STA and/or to all individual TWT agreements followed by the TWT requesting STA.

The All member TWT subfield is set to a first state (e.g., 1) if the resumption applies to all broadcast TWT schedules followed by the TWT scheduled STA and all other TWT scheduled STAs and/or to all individual TWT agreements followed by the TWT requesting STA and all other TWT requesting STAs associated with the same AP.

The Next TWT subfield may contain any nonzero value if Flexible TWT Schedule Support field in the UHR Capabilities element received from the peer STA is set to a first state (e.g., 1).

A Next TWT subfield is not present if the frame is transmitted by AP or non-AP STA to indicate suspension of the individual TWT agreement or broadcast TWT schedule.

The All TWT subfield is set to a first state (e.g., 1) if the suspension applies to all broadcast TWT schedules followed by the TWT scheduled STA and/or to all individual TWT agreements followed by the TWT requesting STA.

The All member TWT subfield is set to a first state (e.g., 1) if the suspension applies to all broadcast TWT schedules followed by the TWT scheduled STA and all other TWT scheduled STAs and/or to all individual TWT agreements followed by the TWT requesting STA and all other TWT requesting STAs.

The AP or non-AP STA can enter into the dozing state after the current TWT SP has expired or been terminated even if it hasn't transmitted or received any non-zero Next TWT information.

The AP and/or the non-AP STA can wake up outside the negotiated TWT SPs, during which the AP and/or the non-AP STA is in doze mode and can wake up after the Next TWT as indicated by a cross link signal that is transmitted or received by another AP and/or non-AP STA that is affiliating with the same AP MLD and/or non-AP MLD on another link.

In at least one embodiment, if the TWT Information element contains an All Member TWT subfield, the All TWT subfield can be reserved or ignored.

In at least one embodiment, if the TWT Information element contains a non-zero All Member TWT subfield, it should be carried by a Beacon frame or cross-link signals so that all non-AP MLDs can obtain this information from either the current operating link or from another affiliated link.

In at least one embodiment, when the TWT Information frame contains an All TWT subfield set equal to a first state (e.g., 1), then the suspension and resumption rules as indicated in the TWT information frame apply to all individual TWT agreements, except that the resumptions of the respective TWTs shall occur at the first TWT of the respective TWT agreement that occurs not earlier than the Next TWT value contained in the TWT Information frame, regardless of the value of the Flexible TWT Schedule Support field in the UHR Capabilities element exchanged between the two STAs.

In another embodiment, if the TWT Information frame contains an All member TWT subfield equal to a first state (e.g., 1), then the suspension and resumption rules as indicated in the TWT information frame apply to all individual TWT agreements corresponding to all associated non-AP STAs, except that the resumptions of the respective TWTs shall occur at the first TWT of the respective TWT agreement that occurs not earlier than the Next TWT value contained in the TWT Information frame, regardless of the value of the Flexible TWT Schedule Support field in the UHR Capabilities element exchanged between the two STAs.

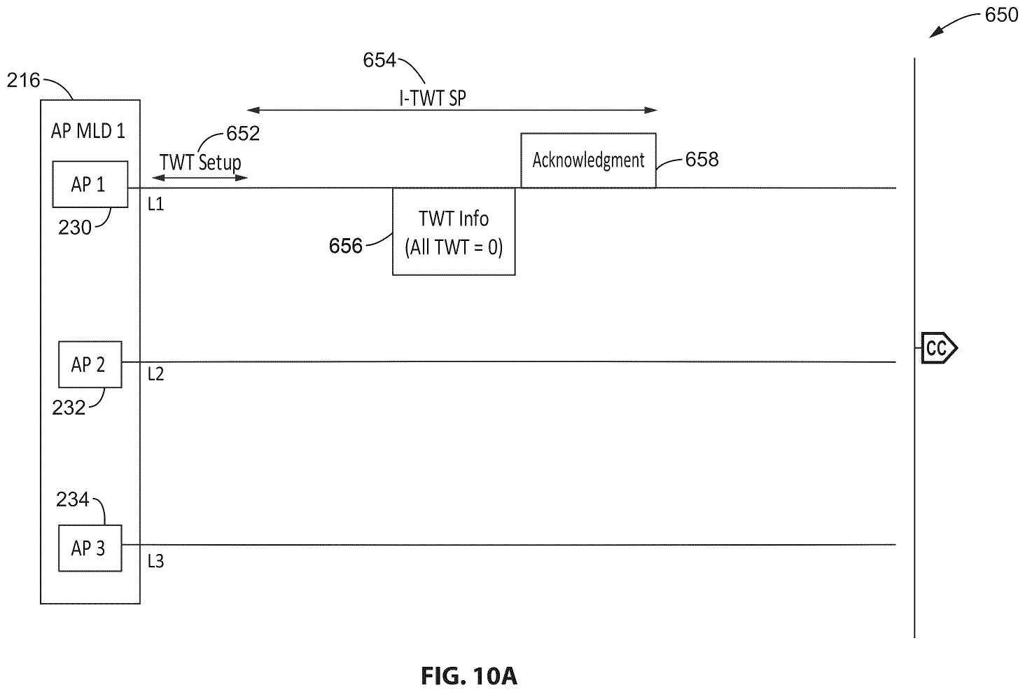

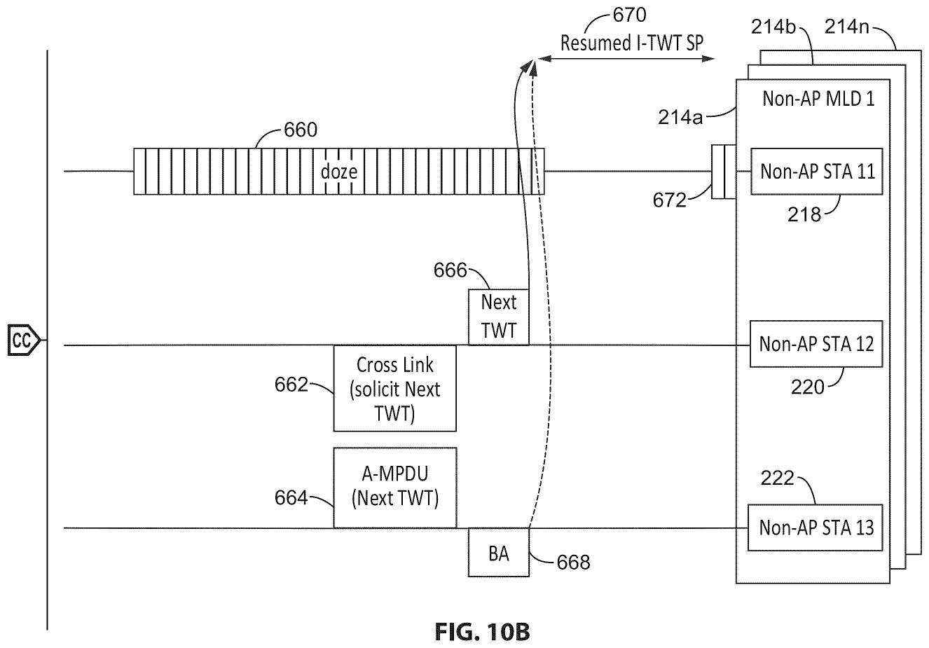

FIG. 10A and FIG. 10B illustrate an example 650 of resuming an individual TWT through cross-link transition, where an AP MLD, in this example AP MLD 1 216 is associated with multiple non-AP MLDs, 214a, 214b through 214n, each by way of example having three non-AP STAs, such as 218, 220 and 222 as seen for non-AP MLD 1 214a. There are multiple established links, three in this example, between AP MLD 1 and its associated non-AP STAs, identified as L1, L2 and L3 respectively. AP1, AP2 and AP3 are operating on L1, L2 and L3, respectively and are in active mode or awake state in the PS mode. After an I-TWT setup procedure 652, AP1 on L1 successfully setup an I-TWT SP 654 with a non-AP STA. Inside the first I-TWT SP, both AP1 and the I-TWT member STA are in active mode or awake state in PS mode.

Before the end of the first I-TWT SP, the I-TWT member STA sends a TWT information frame 656 to AP1 to suspend the I-TWT SP. The TWT Information frame has the All TWT flag set to a first station (e.g., 1) and does not contain Next TWT information, which means the I-TWT SP should be suspended until it has been resumed by exchanging, for example another TWT Information frame indicating a non-zero Next TWT value. The suspension has been acknowledged 658 by AP1.

After the first I-TWT SP is completed, although AP1 and the I-TWT member STA haven't exchanged another TWT Information frame carrying the non-zero Next TWT on L1, they can still enter into the dozing mode 660. When AP1 and the I-TWT member STA are in doze mode on L1, non-AP MLDs can send cross-link signals 662, 664 to AP2 and AP3 on L2 and L3, respectively, which solicits the non-zero Next TWT value the AP1 would wake up on L1.

In this example, the non-AP MLD, with which the I-TWT member STA is affiliated, transmits a cross-link signal 662 to AP2 soliciting the start time of the Next TWT on L1. AP2 could respond with a frame indicating the Next TWT 666 information on L1. Another option is when AP1 is in doze mode on L1, AP2 and AP3 can carry the non-zero Next TWT information on L1 in the transmitted A-MPDU 664 on L2 and L3, respectively. The non-AP MLD with I-TWT member STA affiliated may carry the acceptance (e.g., Block Ack) 668 of the next TWT on L1 in the response frame. In this example, the AP3 carries the wake-up schedule in A-MPDU transmitted on L3. After which it can be seen that the I-TWT SP has been resumed 670, and there may be doze states 672 between SPs.

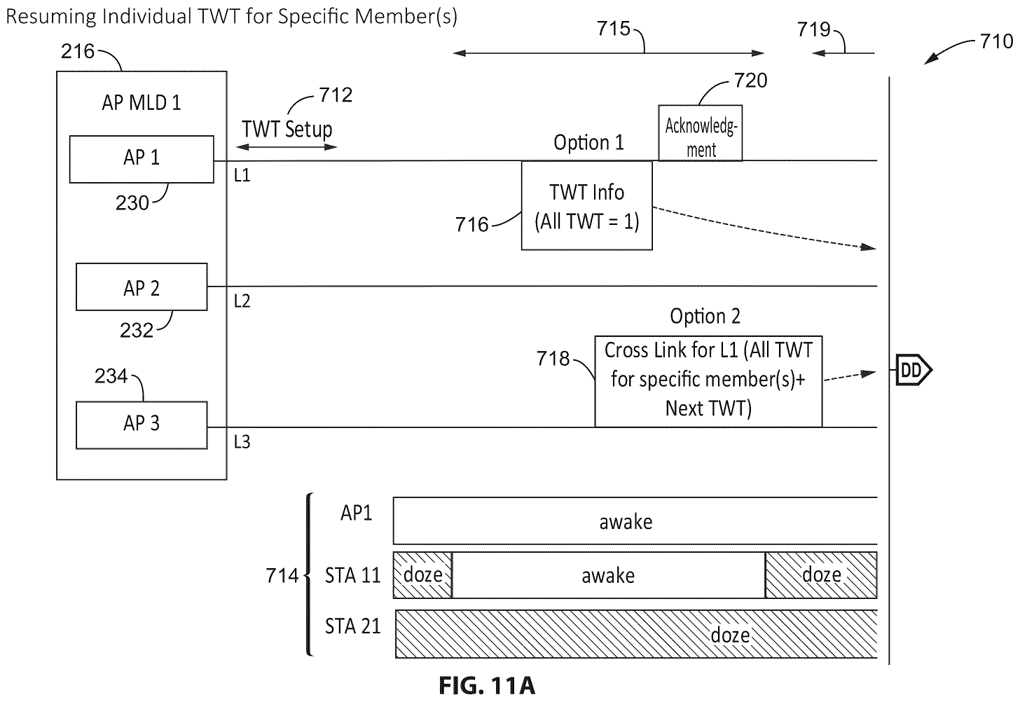

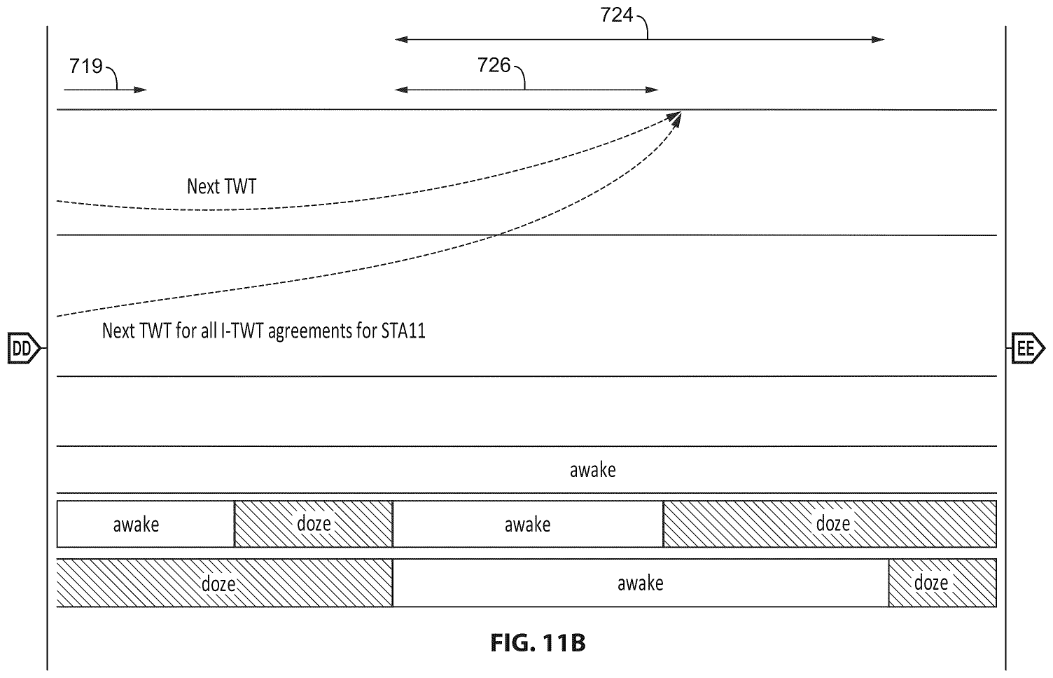

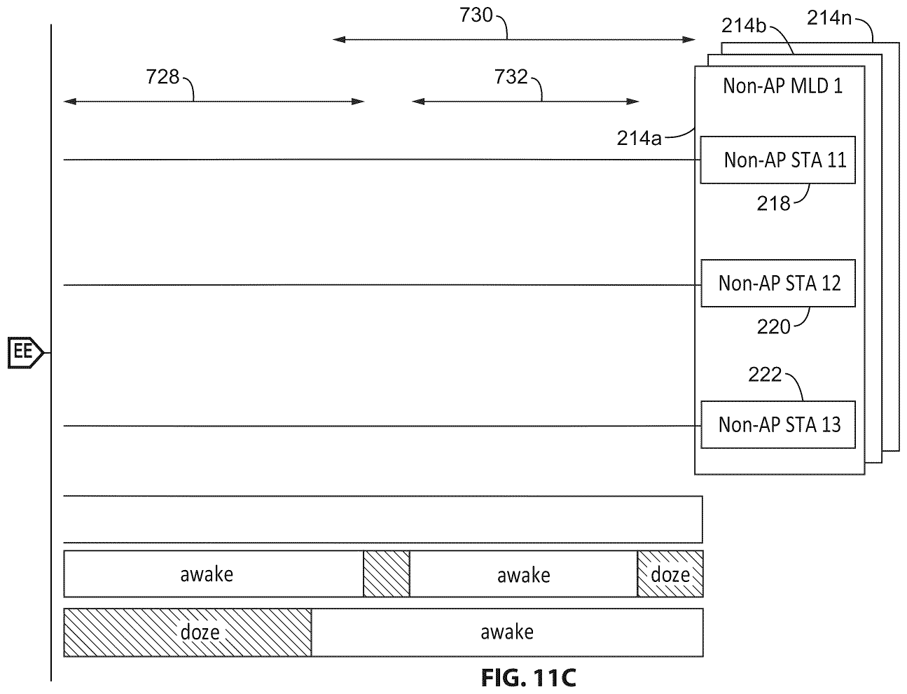

FIG. 11A through FIG. 11C illustrate 710 resuming an individual TWT corresponding to specific TWT member(s) through Cross-link transition on one active link.

An example of resuming an individual TWT corresponding to specific TWT member(s) is shown in the figure, where an AP MLD, exemplified as AP MLD1 216 is associated with multiple non-AP MLDs 214A, 214b through 214n, each exemplified with three non-AP STAs, 218, 220 and 222 as per non-AP MLD 214a. There are multiple established links, three in this example, between AP MLD 1 and its associated non-AP STAs, identified as L1, L2 and L3 respectively. AP1, AP2 and AP3 are operating on L1, L2 and L3, respectively and are in active mode or awake state in PS mode.

After the I-TWT setup procedure 712, AP1 on L1 successfully sets up two implicit I-TWT agreements shown as option 1 (1-TWT ID 1 <STA11, AP1>) 715. Option 2 718 is shown with TWT ID 2 <STA11, AP1>) with STA 11 affiliated with non-AP MLD 1, and one implicit I-TWT agreement (1-TWT ID 1 <STA21, AP1>) with STA21 affiliated with non-AP MLD 2.

At the bottom of this figure is shown the states 714 of AP1, STA11 and STA 21, between awake and doze.

Inside the first TWT SP of I-TWT ID 1 <STA11, AP1>, both AP1 and the STA11 are in active mode or awake state in PS mode. Before the end of this I-TWT SP, STA11 sends a TWT information frame 716 to AP1 to suspend all I-TWT SPs of both I-TWT ID 1 <STA11, AP1> and TWT ID 2 <STA11, AP1> and indicating All TWT set to a first state (e.g., 1) and a non-zero Next TWT value. AP1 responds with an Acknowledgement 720 on L1.

Before the indicated Next TWT time, one I-TWT SP with ID 2 <STA11, AP1>715 and one I-TWT SP with TWT ID 1 <STA11, AP1>719 have been skipped on L1. After the indicated Next TWT time, one I-TWT SP with ID 1 <STA11, AP1>728 and one I-TWT SP with TWT ID 2 <STA11, AP1>732 have been resumed on L1.

Another option is AP2 and AP3 could transmit a cross-link frame anytime on L2 and L3, respectively, for suspension and resumption of all I-TWT SPs on L1 for STA11 with indicating All TWT set to a first state (e.g., 1), and having a non-zero Next TWT value. In this example, AP3 transmits the cross-link signal 718 on L3. The suspension and resumption are only applied to all I-TWT SPs for STA11, it doesn't suspend and resume the I-TWT SP for STA21 724, 730, thus the I-TWT SPs with ID 1 <STA21, AP1> are performed based on the original TWT agreement. The power save status for AP1, STA11 and STA21 are shown in the bottom of the figure, with the edges aligned with the start/end points of the I-TWT SPs on L1.

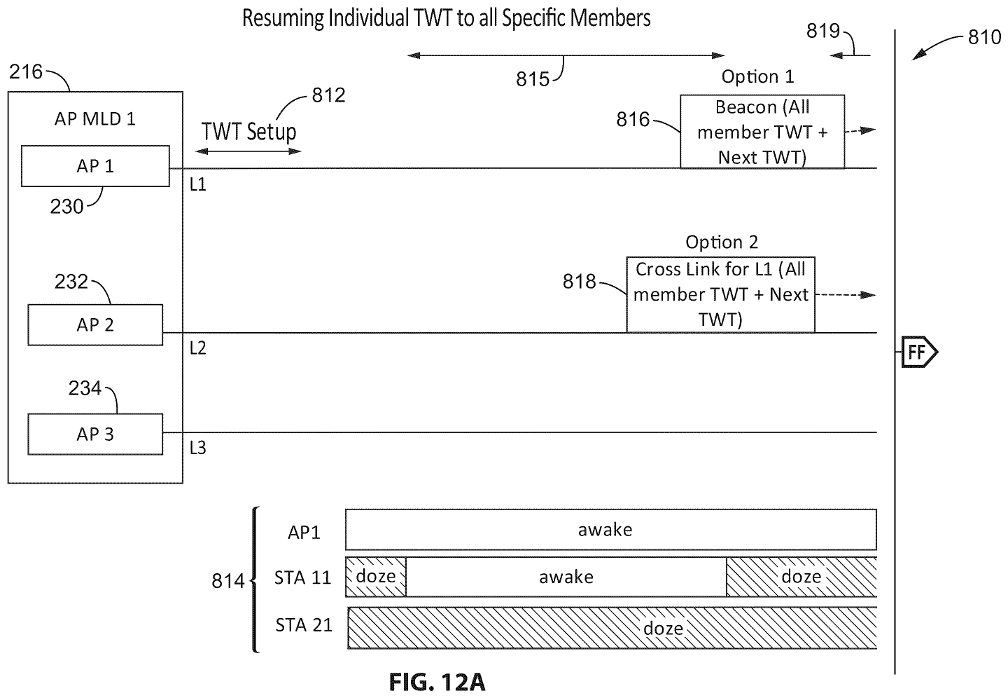

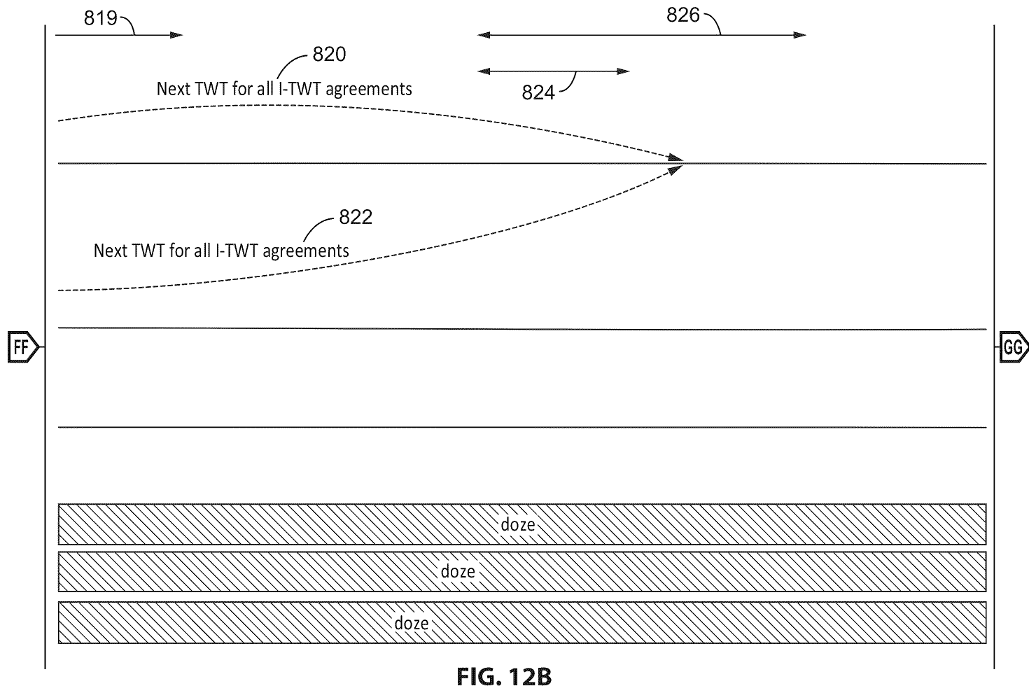

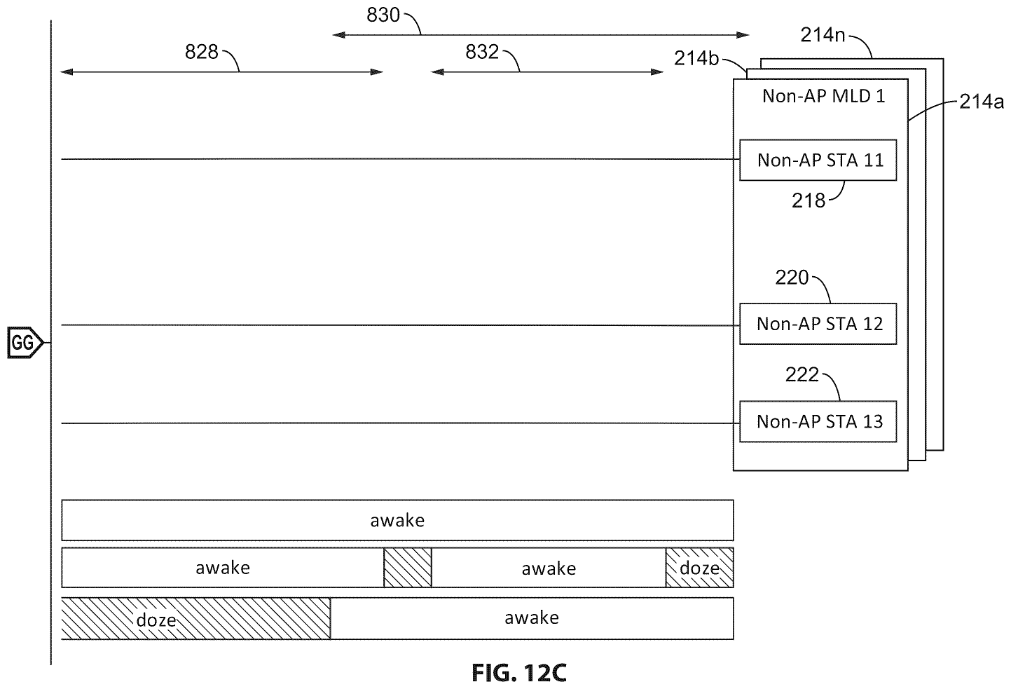

FIG. 12A through FIG. 12C Illustrate 810 resuming individual TWT corresponding to all TWT members through a Cross-link transition on one active link.

An example is shown of resuming individual TWT corresponding to all TWT members through a cross-link transition, where an AP MLD, shown as AP MLD 1 216, is associated with multiple non-AP MLDs, exemplified as non-AP MLD 214a, non-AP MLD 214b, and non-AP MLD 214n. There are multiple links (e.g., three in this example) established between AP MLD 1 and its associated non-AP STAs, identified as L1, L2 and L3 respectively. AP1, AP2 and AP3 are operating on L1, L2 and L3, respectively and are in active mode or awake state in PS mode.

After the I-TWT setup procedure 812, AP1 on L1 successfully sets up two implicit I-TWT agreements (1-TWT ID 1 <STA11, AP1>815 and TWT ID 2 <STA11, AP1>) 819 with STA 11 affiliated with non-AP MLD 1, and one implicit I-TWT agreement (1-TWT ID 1 <STA21, AP1>) 826 with STA21 affiliated with non-AP MLD 2. AP1, STA11 and STA21 enter doze mode outside each I-TWT SPs on L1, except at each TBTT on L1, they should be awake to transmit or receive the Beacon frame.

In this example, a Beacon frame 816 is transmitted after the first TWT SP of I-TWT ID 1 <STA11, AP1>815. The Beacon frame carries the information to suspend and resume I-TWT SPs for all of the associated STAs of AP1 (STA11 and STA21 in this example) which have setup I-TWT agreements with AP1, setting a new bit All Member TWT set to a first state (e.g., 1) designed to achieve this purpose. The Beacon frame thus is set with All Member TWT set to 1 and indicating a non-zero Next TWT value.

Before the indicated Next TWT time, three I-TWT SPs identified by I-TWT ID 2 <STA11, AP1> 819, I-TWT ID 1 <STA11, AP1> 824, and I-TWT ID 1 <STA21, AP1> 826 have been skipped on L1. After the indicated Next TWT time, three I-TWT SPs as identified by I-TWT ID 1 <STA11, AP1> 828, I-TWT ID 2 <STA11, AP1> 832 and I-TWT ID 1 <STA21, AP1> 830 have been resumed on L1.

Another option is AP2 and AP3 can at any time transmit a cross-link frame on L2 and L3, respectively, for suspension and resumption of all I-TWT SPs on L1 for STA11 and STA21 indicating All Member TWT set to a first state (e.g., 1), and indicating the Next TWT start time. In this example, AP3 transmits the cross-link signal on L3. The power save status for AP1, STA11 and STA21 are shown at the bottom of the figures, having edges which align with the start/end points of the I-TWT SPs on L1.

In at least one embodiment, a TWT scheduled STA that receives an acknowledgment in response to a TWT Information frame transmitted by the STA that contains an All TWT subfield equal to a first state (e.g., 1) and contains a Next TWT subfield, shall suspend all broadcast TWT schedules and shall resume the broadcast TWT schedules at the first scheduled TWT for each respective broadcast TWT schedule that occurs not earlier than the value indicated in the Next TWT subfield contained in the transmitted TWT Information frame, regardless of the values of the Flexible TWT Schedule Support field in the UHR Capabilities element exchanged between the two STAs.

In another embodiment, each TWT scheduled STA that receives an acknowledgment in response to a TWT Information frame transmitted by the STA that contains an All Member TWT subfield equal to a first state (e.g., 1) and contains a Next TWT subfield, shall suspend all broadcast TWT schedules and shall resume the broadcast TWT schedules at the first scheduled TWT for each respective broadcast TWT schedule that occurs not earlier than the value indicated in the Next TWT subfield contained in the transmitted TWT Information frame, regardless of the values of the Flexible TWT Schedule Support field in the UHR Capabilities element exchanged between the two STAs.

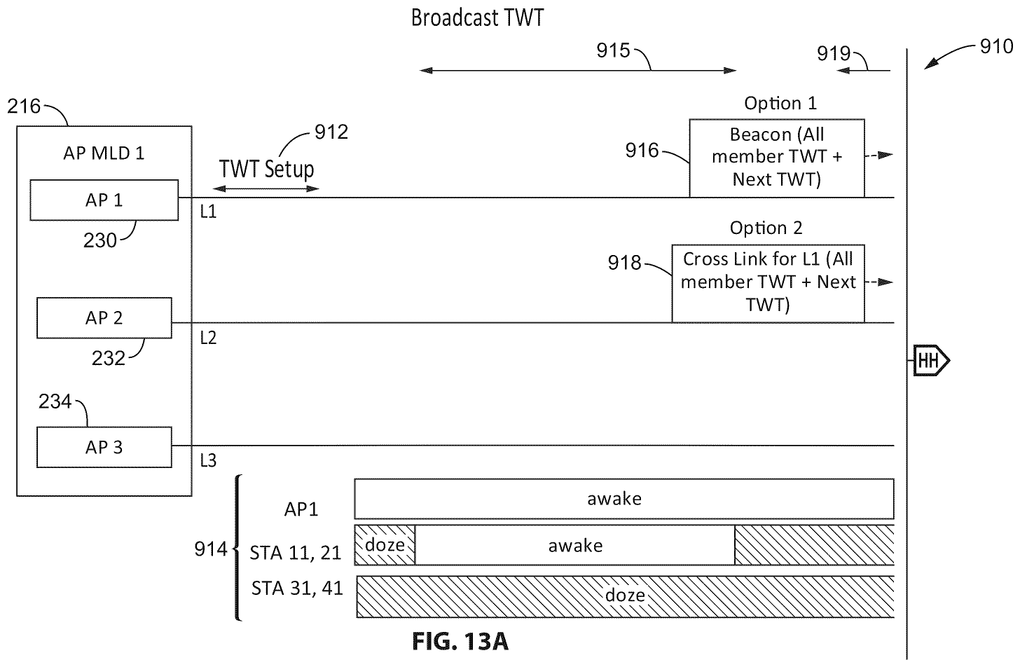

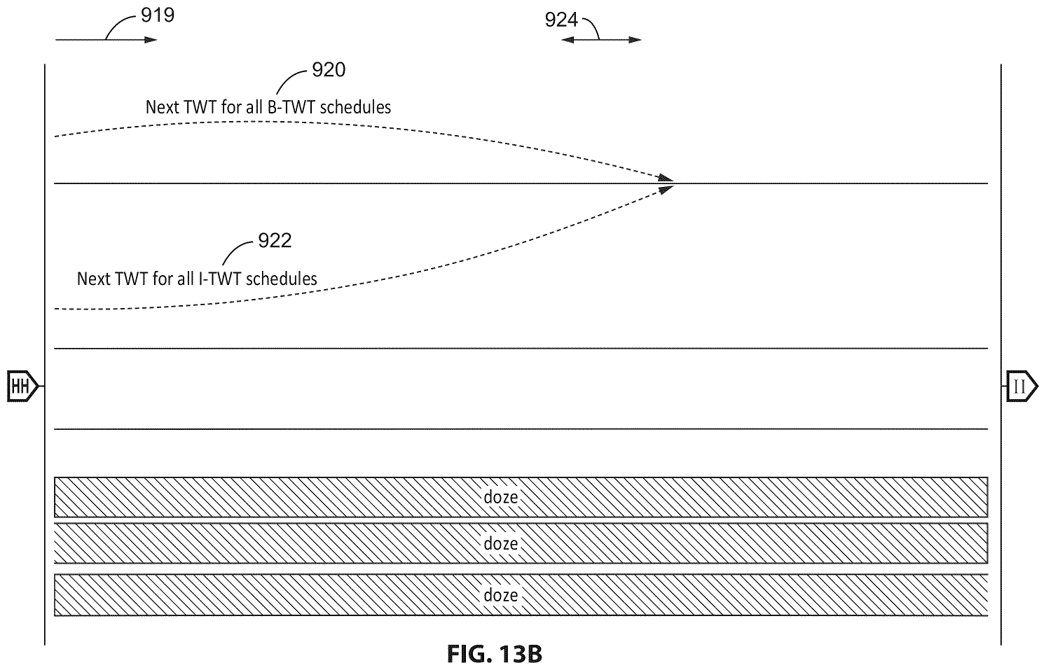

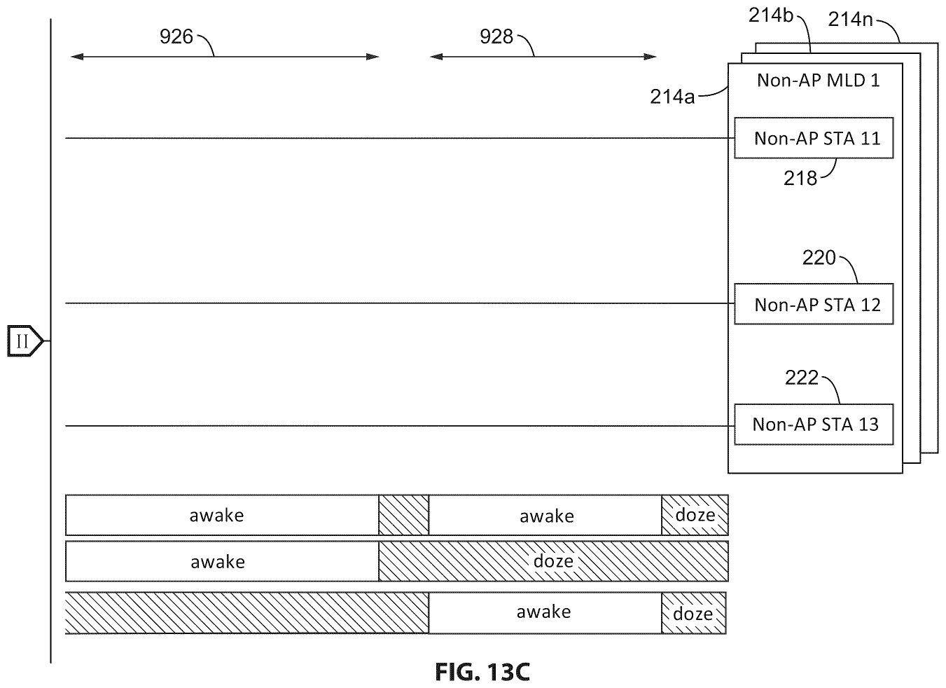

FIG. 13A through FIG. 13C illustrate an example 910 of resuming a broadcast TWT corresponding to all TWT member through Cross-link transition on one active link.

The example shows resuming a broadcast TWT corresponding to all TWT members through cross-link transition, where an AP MLD, in this case AP MLD1 216 is associated with multiple non-AP MLDs, shown with non-AP MLD 214a, non-AP MLD 214b, and non-AP MLD 214n. There are multiple established links, three in this example, between AP MLD 1 and its associated non-AP STAs, identified as L1, L2 and L3 respectively. AP1 230, AP2 232 and AP3 234 are operating on L1, L2 and L3, respectively and are in active mode or awake state in PS mode.

After the I-TWT setup procedure 912, AP1 on L1 successfully sets up two implicit B-TWT schedules (B-TWT ID 1 <STA11, STA21, AP1> 915 and TWT ID 2 <STA11, STA21, AP1>) 924 with STA 11 affiliated with non-AP MLD 1 and STA 21 affiliated with non-AP MLD 2, and another one implicit B-TWT schedule (B-TWT ID 1 <STA31, STA41, AP1>) 919 with STA31 affiliated with non-AP MLD 3 and STA41 affiliated with non-AP MLD 4.

AP1, STA11, STA21, STA31 and STA41 enter doze mode outside each B-TWT SPs on L1, except at each TBTT on L1, they should be awake to transmit or receive the Beacon frame. In this example, a Beacon frame 916 is transmitted after the first TWT SP of B-TWT ID 1 <STA11, AP1> 915. The Beacon frame carries the information to suspend and resume I-TWT SPs for all of the associated STAs (STA11, STA21, STA31 and STA41 in this example) of AP1 which has set up B-TWT agreements with AP1, setting a new bit All Member TWT set to a first state (e.g., 1) to achieve this purpose. The Beacon frame thus sets All Member TWT to a first state (e.g., 1) and indicates a non-zero Next TWT value.

Before the indicated Next TWT time, two B-TWT SPs identified by B-TWT ID 1 <STA31, STA41, AP1> 919 and B-TWT ID 1 <STA11, STA21, AP1> 924 have been skipped on L1.

After the indicated Next TWT time, two B-TWT SPs are performed as identified by and B-TWT ID 1 <STA11, STA21, AP1> 926 and B-TWT ID 1 <STA31, STA41, AP1> 928 have been resumed on L1. Another option is AP2 and AP3 can transmit a cross-link frame anytime on L2 and L3, respectively, to perform suspension and resumption of all B-TWT SPs on L1 for STA11, STA21, STA31 and STA41 indicating All Member TWT set to a first state (e.g., 1), and with a non-zero Next TWT value. In this example, AP2 transmits the cross-link signal on L2. The power save status for AP1, STA11, STA21, STA31 and STA41 are shown at the bottom of the figure, with the edges aligned with the start/end point of the B-TWT SPs on L1.

### 9.2. Explicit TWT for Broadcast TWT

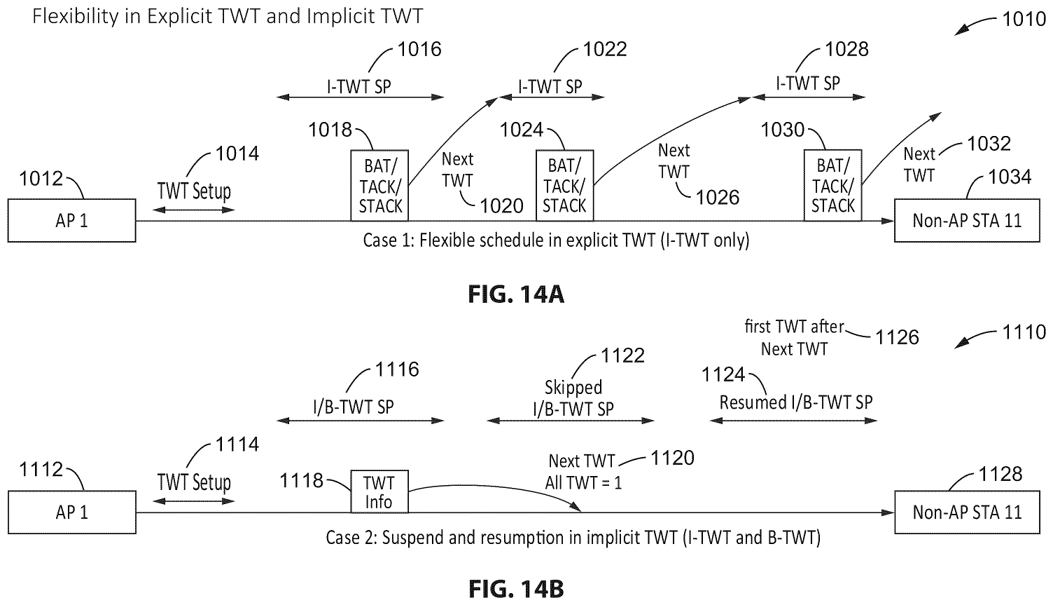

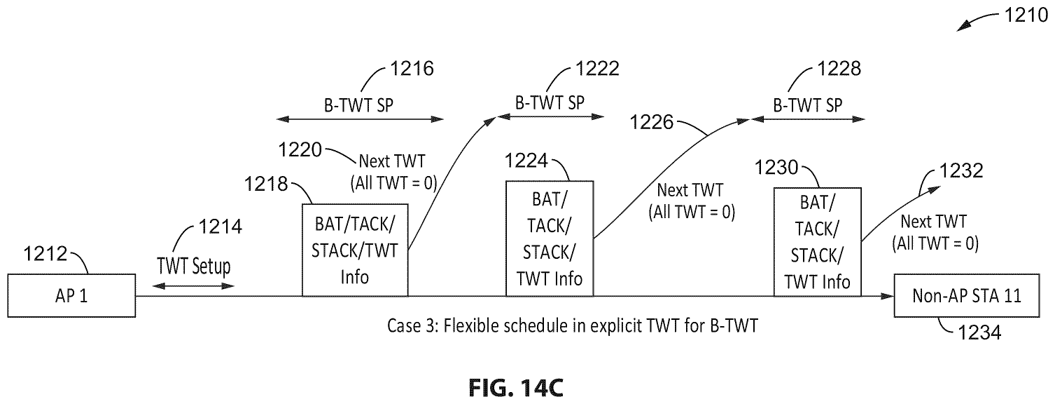

FIG. 14A through FIG. 14C illustrate the flexibility in explicit TWT and implicit TWT.

In FIG. 14A (Case 1) is shown 1010 the limitations of current flexibility designs for TWT, in which which the TWT can indicate explicitly the position of the Next TWT, but it can only be applied for an individual TWT.

In FIG. 14B (Case 2) shows 1110 the limitation of the suspension and resumption function signaled by the TWT Information frame. The current TWT Information frame cannot provide as much flexibility as explicit TWT. It cannot schedule TWT SP between two subsequent TWT SPs when All TWT is set to a first state (e.g., 1) or if any side of the TWT peer doesn't support Flexible TWT schedule.

In FIG. 14C (Case 3) shows 1210 the expected performance by enabling explicit TWT for broadcast TWT, which is described in this disclosure to provide more flexibility for broadcast TWT members.

As shown in FIG. 14A (Case 1), the explicit TWT is currently unavailable for broadcast TWT. AP1 1012 first sets up I-TWT 1014 with non-AP STA11 1034 with an agreed start time of the first I-TWT SP, the first I-TWT SP 1016 then starts at the scheduled time, and at the end of the I-TWT SP, AP1 transmit a BAT frame or TACK frame or STACK frame 1018 to non-AP STA11 to indicate the start time of the next TWT 1020 with I-TWT SP 1022. It should be noted that BAT/TACK/STACK frames are existing frames in baseline, as a Block Acknowledgment TWT (BAT), TWT Acknowledgment (TACK), and Short TWT Acknowledgment (STACK).

Then the next I-TWT SP 1022 starts at the scheduled time and the rest operations 1024, 1026, 1028, 1030 and 1034 repeat this procedure.

As shown in FIG. 14B (Case 2), the flexibility based on implicit TWT could be applied to both individual TWT and broadcast TWT. However, the flexibility achieved by using the TWT Information frame supports skipping one or more B-TWT SPs but cannot schedule a B-TWT within two subsequent B TWT SPs.

AP1 1112 first sets up 1114 repeating I-TWT or B-TWT SPs 1116 with non-AP STA11 1128. The first I/B-TWT SP 1116 starts at the scheduled time. At the end of the first I/B-TWT SP, AP1 sends a TWT Information frame 1118 to non-AP STA11. The TWT Information frame carries the Next TWT field which indicates the earliest time of the next TWT, and sets 1120 All TWT fields to 1. Since the time indicated in the Next TWT field is later than the second I/B-TWT SP 1122, the second I/B-TWT SP 1122 is skipped and the next I/B-TWT SP is resumed in the third I/B-TWT SP 1124, in the first TWT after the Next TWT 1126.

The design of explicit TWT for B-TWT as shown in FIG. 14C (Case 3) can resolve this issue. AP1 1212 first sets up 1214 the first B-TWT SP with non-AP STA11 1234. The first B-TWT SP 1216 then starts at the scheduled time, and at the end of the B-TWT SP, AP1 transmits a BAT frame or TACK frame or STACK frame 1218 to non-AP STA11 to indicate the start time of the next B-TWT SP 1220 with all TWT set to 0. Then the next B-TWT SP 1222 starts at the scheduled time and the remaining operations 1224, 1226, 1228, 1230, and 1232 repeat this procedure.

In at least one embodiment, during an explicit TWT SP, the broadcast (B-)TWT scheduling AP and B-TWT scheduled non-AP STA(s), as members of the current TWT SP, should exchange frames that carry a Next TWT Info/Suspend Duration field, or a Next TWT field, or a duration of Next TWT. The Next TWT Info/Suspend Duration field or the Next TWT field may contain the value of the TSF timer corresponding to the next scheduled TWT SP for the B-TWT scheduling AP and/or the B-TWT scheduled non-AP STA(s) as the member of current TWT SP. The Next TWT Info/Suspend Duration field or the Next TWT field may contain the value 0 to indicate that the Next TWT is not currently available for this TWT.

In at least one embodiment, a broadcast (B-)TWT scheduling AP and/or the B-TWT scheduled non-AP STA(s) that is not affiliated with the MLD and is awake for an explicit TWT SP shall not enter into doze state until it has transmitted/received a nonzero Next TWT Info/Suspend Duration field or a non-zero Next TWT field and has either been in the awake state for a duration of at least Nominal Minimum TWT Wake Duration from the TWT SP start time or has transmitted/received an EOSP field equal to 1.

In another embodiment, a broadcast (B-)TWT scheduling AP and/or the B-TWT scheduled non-AP STA(s) that is affiliated with MLD and is awake for an explicit TWT SP may enter dozing state without it having transmitted or received a nonzero Next TWT Info/Suspend Duration field or a nonzero Next TWT field and has either been in the awake state for a duration of at least Nominal Minimum TWT Wake Duration from the TWT SP start time or has transmitted/received an EOSP field equal to 1. The Next TWT Info/Suspend Duration field information or the Next TWT field information can be transmitted/received on another link carried by a Cross Link signal.

In at least one embodiment, the Next TWT Info/Suspend Duration field information or the Next TWT Info can be solicited or carried by a PPDU containing a TWT Information frame received on the operating link or on another link through a cross-link signal.

In at least one embodiment, a broadcast (B-)TWT scheduling AP and/or the B-TWT scheduled non-AP STA(s) that has transmitted a frame containing a Next TWT subfield equal to 0, or a Next TWT Info/Suspend Duration field to 0 shall queue for transmission at least one frame over the same operating link or on another active link to the same recipient or the same MLD that the recipient is affiliate with, containing the nonzero Next TWT corresponding to the broadcast TWT ID, and/or link ID indicated in the frame with the Next TWT subfield equal to 0.

In at least one embodiment, if a broadcast (B-)TWT scheduling AP or the B-TWT scheduled non-AP STA(s) that is in PS-mode and is not affiliating with a MLD and has received or transmitted a frame soliciting a response that contains a Next TWT value, the B-TWT scheduling AP or B-TWT scheduled non-AP STA(s) shall remain in the awake state following the transmission until it transmits or receives a response that contains a nonzero Next TWT value on the same operating link.

In another embodiment, if a broadcast (B-)TWT scheduling AP and/or the B-TWT scheduled non-AP STA(s) that is in a Power Save mode and is affiliating with a MLD and has entered doze state, another AP affiliated with the same AP MLD as the B-TWT scheduling AP and another non-AP STA affiliate with the same non-AP MLD as the B-TWT scheduled non-AP STA can transmit or receive the frame soliciting a response that contains a Next TWT value on another link on behave of the B-TWT scheduling AP and the B-TWT scheduled non-AP STA(s), which is in doze state until the Next TWT time as indicated by a response that contains a nonzero Next TWT value as indicated in the response frame received on the other link.

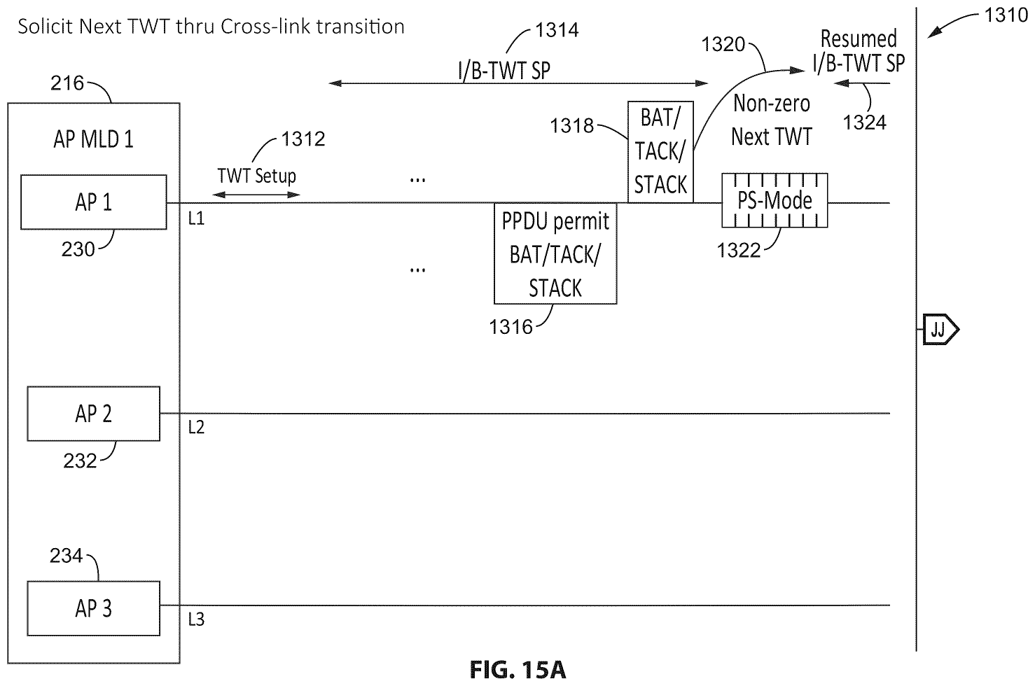

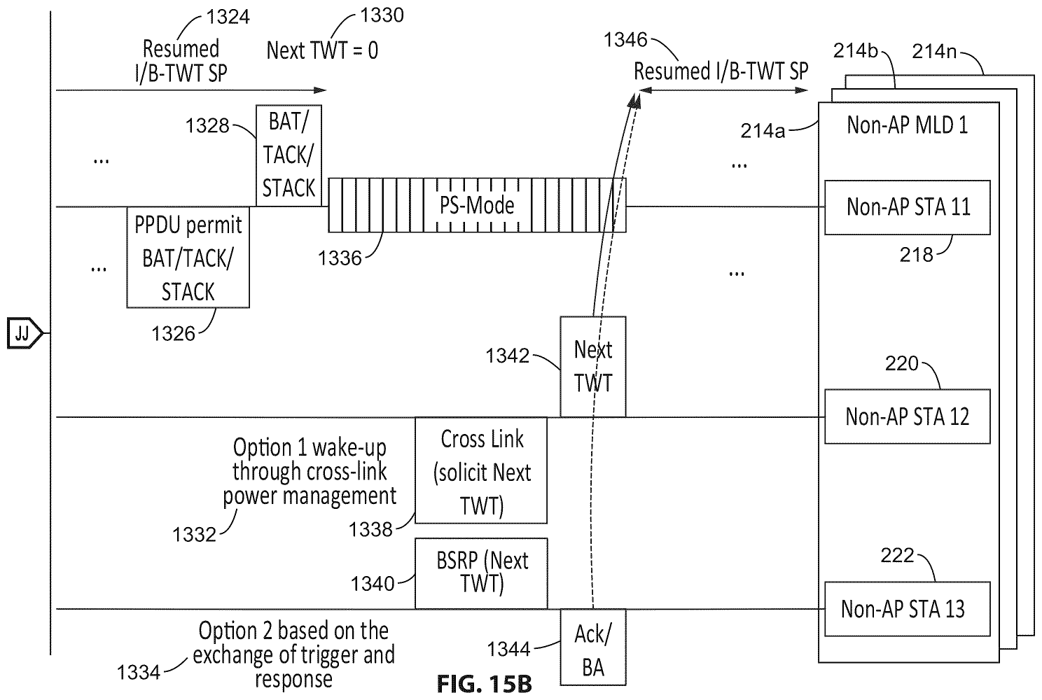

FIG. 15A and FIG. 15B illustrate an example 1310 on soliciting the next TWT through Cross-link transition on one active link, where an AP MLD (e.g., AP MLD1 216) is associated with multiple non-AP MLDs, exemplified as non-AP MLD 214a, non-AP MLD 214b, and non-AP MLD 214n. There are multiple established links (e.g., three in this example) between AP MLD1 and its associated non-AP STAs, identified as L1, L2 and L3 respectively. AP1, AP2 and AP3 are operating on L1, L2 and L3, respectively and are in active mode or awake state in PS mode.

After the I/B-TWT setup procedure 1312, AP1 on L1 successfully setup an I/B-TWT SP 1314 with a non-AP STA. Inside the first I/B-TWT SP, both AP1 and the I/B-TWT member STA(s) are in active mode or awake state in PS mode.

Before the end of the first I/B-TWT SP 1314, the I/B-TWT member STA sends a UL (MU) PPDU 1316 to AP1 to permit BAT/TACK/STACK frames and receives from AP1 BAT/TACK/STACK frames 1318, which contains a non-zero Next TWT information 1320, which indicates the I/B-TWT SP should be suspended until it has been resumed at the Next TWT time. AP1 then enters PS mode 1322.

The resumed I/B TWT SP 1324 starts at the indicated Next TWT time, during the resumed I/B TWT SP, both AP1 and the I/B-TWT member STA(s) are in active mode or awake state in PS mode.

Before the end of the resumed I/B-TWT SP 1324, the I/B-TWT member STA sends a UL (MU) PPDU 1326 to AP1 which permits an AP response 1328 with BAT/TACK/STACK frames, which contains an invalid Next TWT information, which means the I/B-TWT SP should be suspended until it has been resumed 1346 by exchanging PPDU and BAT/TACK/STACK frames with an indication of a non-zero Next TWT value.

After the resumed I/B-TWT SP is finished, although AP1 and the I-TWT member STA have not yet exchanged another BAT/TACK/STACK frame carrying the non-zero Next TWT on L1, they could still enter doze mode 1336.

When AP1 and the I/B-TWT member STA(s) are in doze mode on L1, non-AP MLDs can send a cross-link signal 1338, 1340 to AP2 and AP3 on L2 and L3, respectively, which carries the non-zero Next TWT value to wakeup AP1 on L.

In a first option example, the non-AP MLD, with which the I-TWT member STA is affiliated, transmits a cross-link signal 1338 to AP2 to solicit the start time of the Next TWT on L1; to which AP2 respond with a frame 1342 indicating the Next TWT information on L1. Alternatively, AP1 is in doze mode on L1, AP2 and AP3 could carry the non-zero Next TWT information on L1 in the transmitted A-MPDU on L2 and L3, respectively, and receive an acknowledgement which carries the acceptance of the next TWT on L1 from the non-AP MLD with I-TWT member STA affiliated. In this example, the AP3 carries the wake-up schedule in A-MPDU transmitted on L3. When AP1 is in doze mode on L1, other affiliated APs can send a cross-link signal on other links, to indicate the schedule of the wake-up service period (SP) for AP1, including but not limited to the start time and duration of the SP. Non-AP MLDs received this cross-link signal should make sure their affiliated non-AP STAs on L1 also wake up during the wake-up SP and response with acknowledgement. In this example, the cross-link signal for power management is sent by AP2.

Another option is when AP1 is in doze mode on L1, and AP2 and AP3 can carry the schedule of the wake-up service period (SP) for AP1 inside trigger frames such as BSRP trigger 1340. Non-AP MLDs receiving this trigger should make certain their affiliated non-AP STAs on L1 also wake up during the wake-up SP and respond with with a BSR 1344 (Ack/BA). In this example, the trigger frame carrying cross link wake-up SP information is sent by AP3.

### 10. Power Management for Cross-BSS within the Same Multiple BSSID Parameter Set

In current 11be specification Draft P802.11be_D6.0 and Draft P802.11REVme_D5.0, when an AP corresponding to a transmitted BSSID advertises an R-TWT schedule for a non-transmitted BSSID in the same multiple BSSID set, the AP indicates the R-TWT schedule for a non-transmitted BSSID by a Restricted TWT Parameter Set field describing the R-TWT schedule carried in a broadcast TWT element outside the Multiple BSSID element if the R-TWT schedule is active, with the Restricted TWT Schedule Info subfield set to a value of ‘3’ and with the Broadcast TWT ID subfield set to a value of ‘31’.

In at least one embodiment, the TWT-based PS as described in the previous section (Section 9) should also be applied to the R-TWT schedule for the non-transmitted BSSID. The TWT suspension, resumption and power management related transmission for the AP corresponding to the non-transmitted BSSID can be transmitted by the AP corresponding to the transmitted BSSID in the same multiple BSSID set.

In at least one embodiment, when the AP corresponding to the transmitted BSSID goes into the dozing state, unless there is a requirement from other APs corresponding to the non-transmitted BSSID of the same multiple BSSID set to prevent this AP from going into doze state, the AP corresponding to the non-transmitted BSSID of the same multiple BSSID set should also go into the doze state. When the AP corresponding to the transmitted BSSID switches from doze state to active mode or PS mode with an awake state, the AP corresponding to the non-transmitted BSSID of the same multiple BSSID set may not switch to active mode or PS mode with awake state.

### 11. TID-to-Link Mapping (TTLM) for Cross Link Power Management

In at least one embodiment, the link that is used to transmit cross-link power management frames including the cross-link wake-up frame and cross-link sleep frame, should have all TID mapped to its operating link, and/or should be able to receive from all affiliated non-AP MLDs and legacy non-AP STAs on its operating link.

In at least one embodiment, the AP affiliating with an AP MLD should not go into the doze state if it's operating link also has legacy pre-EHT STAs operating on it.

In at least one embodiment, the AP or non-AP STA affiliating with an AP MLD or a non-AP MLD respectively, should not go to doze state if it has UL and/or DL TID(s) only mapped to a single link, which is its operating link, unless the AP or non-AP STA can assure that the other AP(s) or non-AP STA(s) that affiliate with the same AP MLD or non-AP MLD, is in active mode and can receive the cross-link wake-up frames indicating the need for a wake-up to receive the UL and/or DL TID(s) traffic only mapped to that single link.

In at least one embodiment, the TIDs mapped to the link on which AP in PS-Mode is operating on should be a subset of the TIDs that are mapped to the link(s) on which other AP(s) in active mode affiliating with the same AP MLD.

In at least one embodiment, it should set a default TTLM on at least one link, on which the affiliated AP and non-AP STAs should then not go into a dozing state.

In another embodiment, when default TTLM on at least one link is not achievable, a cross-link dynamic TTLM should support the multi-link power saving through dynamic TTLM negotiation to map the TID(s) that is served in the scheduled or non-scheduled power saving SP on another link which the mapping STA will not be in doze state and will not have a scheduled SP with TID restrictions that do not cover the dynamically mapped TID.

In at least one embodiment, the periodical scheduled PS, the TTLM negotiation can carry an additional subfield, such as TTLM interval, duration per SP and persistence of the dynamic TTLM SPs in TID-To-Link Mapping element.

In at least one embodiment, the non-periodical PS period, the negotiation of the dynamic TTLM can be together with the negotiation of the Next SP through exchange of one or two (for UL and DL independently) TID-To-Link Mapping element(s) that could be carried in a TID-To-Link Mapping Request/Response frame or in a management frame. The default TTLM should be set up on another link where the AP/non-AP STA affiliated with the same MLD is in active mode or awake state of the PS-Mode during which the AP/non-AP STA in current operating link is in doze state.

In at least one embodiment, when an AP affiliated with an AP MLD goes into doze state on one link, the dynamic TTLM can temporally map no TID on that link to disable that link for the duration during which the AP is in doze state.

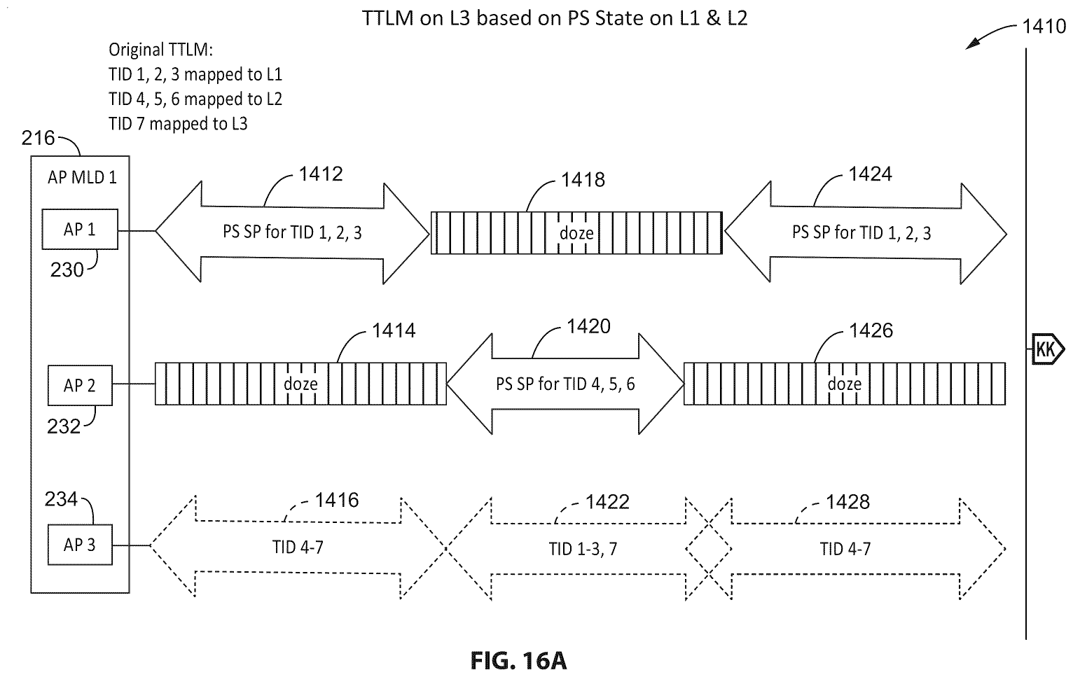

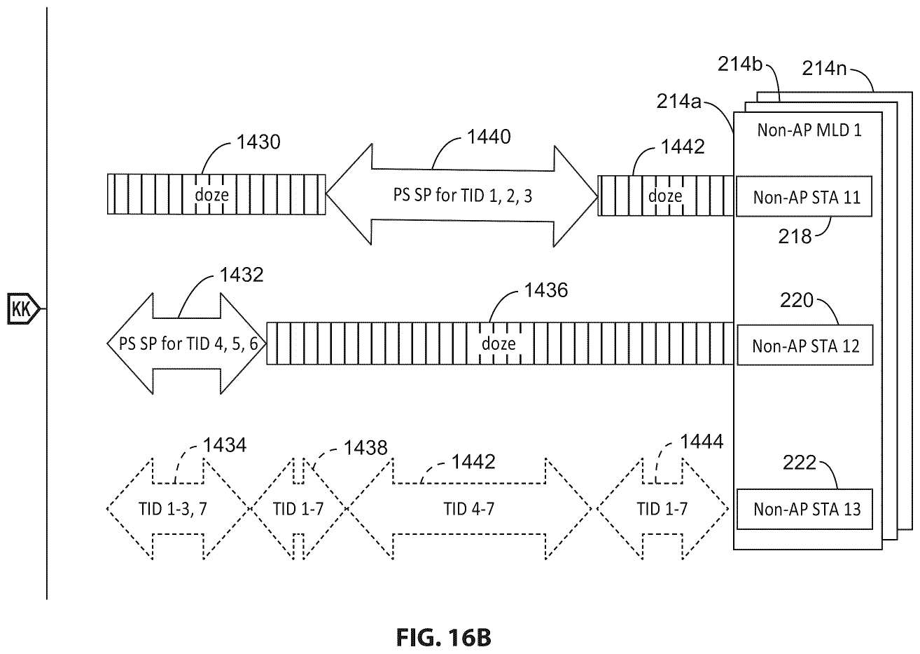

FIG. 16A and FIG. 16B illustrate an example 1410 of Dynamic TTLM on L3 based on PS state on L1 and L2, where an example AP MLD 1 216 is associated with multiple non-AP MLDs depicted as non-AP MLD 214a, non-AP MLD 214b, through to non-AP MLD 214n. There are multiple established links, three in these examples, between AP MLD 1 and its associated non-AP STAs, identified as L1, L2 and L3 respectively. AP1 230, AP2 232 and AP3 234 are operating on L1, L2 and L3, respectively and are in active mode or awake state in PS mode.

When AP MLD1 and associated non-AP MLD1 establishes the multiple-link connections, the initial TTLM results are TID 1-3 are mapped to L1, TID 4-6 are mapped to L2 and TID 7 is mapped to L3.

The PS SPs for TID 1-3 are scheduled for AP1 and/or STA11 on L1 1412, 1424, 1440. The PS SPs for TID 4-6 are scheduled for AP2 and/or STA12 on L2 1420, 1432.

AP1 and STA11 on L1 and AP2 and STA12 on L2 should wake up during the corresponding PS SPs and doze 1418, 1430, 1442, 1414, 1426, 1436 outside the corresponding PS SPs on L1 and L2, respectively. When AP1 and STA11 enter a dozing state outside the corresponding PS SPs on L1, TID1-3 should be mapped to L3 1422, 1434, 1438, 1444. When AP2 and STA12 enter dozed state outside the corresponding PS SPs on L2, TID4-6 should be mapped to L3 1416, 1428, 1438, 1442, 1444.

### 12. Frame Formats

### 12.1. TWT Information Field Format

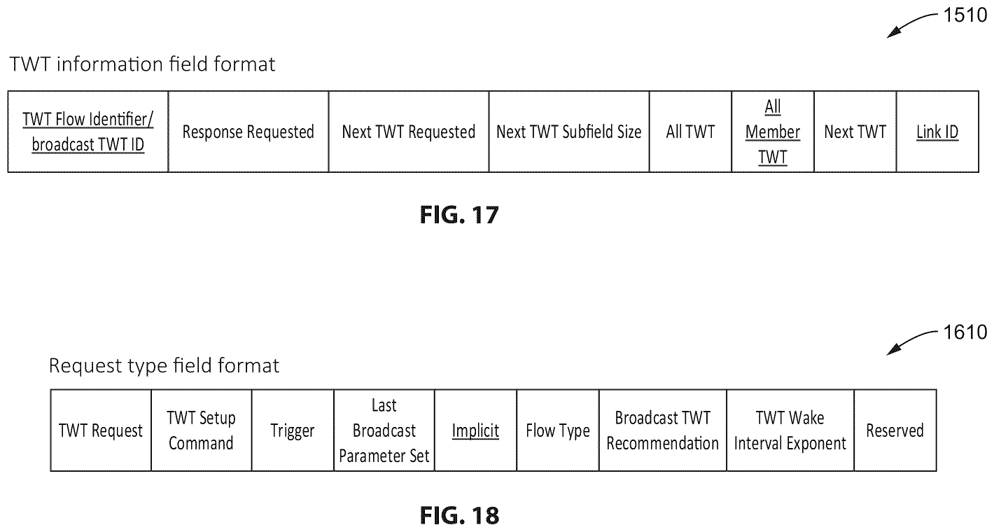

FIG. 17 illustrates an example embodiment 1510 of an enhanced TWT Information field format. In at least one embodiment, the TWT Flow Identifier subfield should be replaced by the broadcast TWT ID when the TWT Information field carried in the TWT Information frame is exchanged between B-TWT scheduling AP and B-TWT scheduled non-AP STA. The broadcast TWT ID subfield contains the broadcast TWT ID for which TWT information is requested or being provided. The broadcast TWT ID subfield is reserved if the All TWT subfield is to a first state (e.g., 1). The other subfield of the TWT Information field is the same as that defined in current specification.

In at least one embodiment, the All Member TWT subfield should be included to extend the application of this TWT Information field from the All TWT corresponding to the all broadcast TWT schedules followed by the TWT scheduled STA and/or to all individual TWT agreements followed by the TWT responding STA to all broadcast TWT schedules followed by the TWT scheduled STA and all other TWT scheduled STAs and/or to all individual TWT agreements followed by the TWT responding STA and all other TWT responding STAs.

In at least one embodiment, the Link ID subfield should be included in the TWT Information field to indicate on which link the information carried in this TWT Information field should be applied.

### 12.2 Request Type Field Format in Broadcast TWT Parameter Set Field

FIG. 18 illustrates an example embodiment 1610 of a Request Type field format embedded in the Broadcast TWT Parameter Set field format. In at least one embodiment, the Explicit (Implicit field set to 0) sub-field should also be included in the Request Type field in Broadcast TWT Parameter Set filed. And the Flexible TWT Schedule Support field can also be included and set up in the UHR Capability element; with this, the Broadcast TWT SP can have the non-periodical pattern. When the explicit TWT is enabled and employed, a TWT scheduling AP and/or the TWT scheduled non-AP STAs, as a member of this broadcast TWT SP can wake up and perform a frame exchange and receive the information for the next target wake time as that designed for individual TWTs in the specification Draft P802.11be_D6.0 and Draft P802.11REVme_D5.0.

### 13. General Scope of Embodiments

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored locally to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A multiple link device apparatus for communication in a wireless network while providing dynamic power saving (PS), the apparatus comprising: (a) a multiple link device (MLD) comprising multiple stations (STAs); (b) wherein all said STAs of the MLD are either access point (AP) STAs or non-AP STAs; (c) at least one processor of said MLD and a non-transitory memory storing instructions executable by the at least one processor for wirelessly communicating from the STAs of said MLD with other STAs on an IEEE 802.11 wireless local area network (WLAN); and (d) wherein said instructions, when executed by the at least one processor, perform steps of a wireless communications protocol, comprising: (d)(i) wherein said STA, and the other STAs of the MLD, can be in either a dozing state or in an active state; (d)(ii) wherein said active state comprises both a fully powered state in which it can transmit and/or receive in a higher powered active state or higher power active mode, and a lower powered active state or lower power active mode in which it is capable of only listening; and (d)(iii) wherein a cross-link signal is sent by said STA through an active link(s) to perform operations on at least one specific link(s) to wakeup a dozing AP or non-AP STA, or to put an active AP or non-AP STA into dozing mode, and suspend and resume target wait time (TWT) agreements and schedules for select TWT members or all TWT member STAs.

A multiple link device apparatus for communication in a wireless network while providing dynamic power saving (PS), the apparatus comprising: (a) a multiple link device (MLD) comprising multiple stations (STAs); (b) wherein all said STAs of the MLD are either access point (AP) STAs or non-AP STAs; (c) at least one processor of said MLD and a non-transitory memory storing instructions executable by the at least one processor for wirelessly communicating from the STAs of said MLD with other STAs on an IEEE 802.11 wireless local area network (WLAN); and (d) wherein said instructions, when executed by the at least one processor, perform steps of a wireless communications protocol, comprising: (d)(i) wherein said STA, and the other STAs of the MLD, can be in either a dozing state or in an active state; (d)(ii) wherein said active state comprises both a fully powered state in which it can transmit and/or receive in a higher powered active state (higher power active mode), and a lower powered active state (lower power active mode) in which it is capable of only listening; (d)(iii) wherein a cross-link signal is sent by said STA through an active link(s) to perform operations on at least one specific link(s) to wakeup a dozing AP or non-AP STA, or to put an active AP or non-AP STA into dozing mode, and suspend and resume target wait time (TWT) agreements and schedules for select TWT members or all TWT member STAs; and (d)(iv) wherein if said STA is operating as an AP STA, then it is configured for performing automatic power save delivery (APSD) including performing unscheduled-APSD (U-APSD) and scheduled-APSD (S-APSD), over one or multiple links or sub-channels.

A method of performing multiple link device communications in a wireless network while providing dynamic power saving (PS), comprising: (a) communicating between STAs of multiple link devices (MLDs) on an IEEE 802.11 wireless local area network (WLAN), with each of said MLDs comprising multiple stations (STAs) which are either access point (AP) STAs or non-AP STAs performing steps of a wireless communications protocol; (b) wherein said STA, and the other STAs of the MLD, can be in either a dozing state or in an active state; (c) wherein said active state comprises both a fully powered state in which it can transmit and/or receive in a higher powered active state or higher power active mode, and a lower powered active state or lower power active mode, in which it is capable of only listening; and (d) wherein a cross-link signal is sent by said STA through an active link(s) to perform operations on at least one specific link(s) to wakeup a dozing AP or non-AP STA, or to put an active AP or non-AP STA into dozing mode, and suspend and resume target wait time (TWT) agreements and schedules for select TWT members or all TWT member STAs.

The apparatus or method of any preceding implementation, wherein if said STA is operating as an AP STA, then it is configured for performing automatic power save delivery (APSD) including performing unscheduled-APSD (U-APSD) and scheduled-APSD (S-APSD), over one or multiple links or sub-channels.

The apparatus or method of any preceding implementation, wherein the AP is enabled to initiate the negotiation with each non-AP STA to establish S-APSD, with scheduling info, service start time, service interval and specification interval.

The apparatus or method of any preceding implementation, wherein the AP is enabled to process U-APSD based PS and to wake up to receive buffered units from its associated non-AP STA(s) at a designated wake-up time.

The apparatus or method of any preceding implementation, wherein said designated wake-up time is received from a different link with a cross-link signal.

The apparatus or method of any preceding implementation, wherein U-APSD and S-APSD operations can coexist.

The apparatus or method of any preceding implementation, wherein explicit TWT operations are extended to operate in a broadcast TWT mode, toward increasing flexibility in having a broadcast TWT SP between two subsequent negotiated broadcast TWT SPs.

The apparatus or method of any preceding implementation, wherein the suspending and resuming of both individual and broadcast TWT for all member STAs improves network efficiency.

The apparatus or method of any preceding implementation, further comprising a dynamic transmission-identifier-to-link mapping (TTLM) which provides cross-link power management to provide power savings on over multiple links.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to +5%, less than or equal to +4%, less than or equal to +3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to 5°, less than or equal to 4°, less than or equal to 3°, less than or equal to ±2°, less than or equal to 1°, less than or equal to 0.5°, less than or equal to 0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A multiple link device apparatus for communication in a wireless network while providing dynamic power saving (PS), the apparatus comprising:
(a) a multiple link device (MLD) comprising multiple stations (STAs);
(b) wherein all said STAs of the MLD are either access point (AP) STAs or non-AP STAs;
(c) at least one processor of said MLD and a non-transitory memory storing instructions executable by the at least one processor for wirelessly communicating from the STAs of said MLD with other STAs on an IEEE 802.11wireless local area network (WLAN); and
(d) wherein said instructions, when executed by the at least one processor, perform steps of a wireless communications protocol, comprising:
(i) wherein said STA, and the other STAs of the MLD, can be in either a dozing state or in an active state;
(ii) wherein said active state comprises both a fully powered state in which it can transmit and/or receive in a higher powered active state or higher power active mode, and a lower powered active state or lower power active mode in which it is capable of only listening; and
(iii) wherein a cross-link signal is sent by said STA through an active link(s) to perform operations on at least one specific link(s) to wakeup a dozing AP or non-AP STA, or to put an active AP or non-AP STA into dozing mode, and suspend and resume target wait time (TWT) agreements and schedules for select TWT members or all TWT member STAs.

2. The apparatus of claim 1, wherein if said STA is operating as an AP STA, then it is configured for performing automatic power save delivery (APSD) including performing unscheduled-APSD (U-APSD) and scheduled-APSD (S-APSD), over one or multiple links or sub-channels.

3. The apparatus of claim 2, wherein the AP is enabled to initiate the negotiation with each non-AP STA to establish S-APSD, with scheduling info, service start time, service interval and specification interval.

4. The apparatus of claim 2, wherein the AP is enabled to process U-APSD based PS and to wake up to receive buffered units from its associated non-AP STA(s) at a designated wake-up time.

5. The apparatus of claim 4, wherein said designated wake-up time is received from a different link with a cross-link signal.

6. The apparatus of claim 2, wherein U-APSD and S-APSD operations can coexist.

7. The apparatus of claim 1, wherein explicit TWT operations are extended to operate in a broadcast TWT mode, toward increasing flexibility in having a broadcast TWT SP between two subsequent negotiated broadcast TWT SPs.

8. The apparatus of claim 1, wherein the suspending and resuming of both individual and broadcast TWT for all member STAs improves network efficiency.

9. The apparatus of claim 1, further comprising a dynamic transmission-identifier-to-link mapping (TTLM) which provides cross-link power management to provide power savings on over multiple links.

10. A multiple link device apparatus for communication in a wireless network while providing dynamic power saving (PS), the apparatus comprising:
(a) a multiple link device (MLD) comprising multiple stations (STAs);
(b) wherein all said STAs of the MLD are either access point (AP) STAs or non-AP STAs;
(c) at least one processor of said MLD and a non-transitory memory storing instructions executable by the at least one processor for wirelessly communicating from the STAs of said MLD with other STAs on an IEEE 802.11 wireless local area network (WLAN); and
(d) wherein said instructions, when executed by the at least one processor, perform steps of a wireless communications protocol, comprising:
(i) wherein said STA, and the other STAs of the MLD, can be in either a dozing state or in an active state;
(ii) wherein said active state comprises both a fully powered state in which it can transmit and/or receive in a higher powered active state (higher power active mode), and a lower powered active state (lower power active mode) in which it is capable of only listening;
(iii) wherein a cross-link signal is sent by said STA through an active link(s) to perform operations on at least one specific link(s) to wakeup a dozing AP or non-AP STA, or to put an active AP or non-AP STA into dozing mode, and suspend and resume target wait time (TWT) agreements and schedules for select TWT members or all TWT member STAs; and
(iv) wherein if said STA is operating as an AP STA, then it is configured for performing automatic power save delivery (APSD) including performing unscheduled-APSD (U-APSD) and scheduled-APSD (S-APSD), over one or multiple links or sub-channels.

11. The apparatus of claim 10, wherein the AP is enabled to initiate the negotiation with each non-AP STA to establish S-APSD, with scheduling info, service start time, service interval and specification interval.

12. The apparatus of claim 10, wherein the AP is enabled to process U-APSD based PS and to wake up to receive buffered units from its associated non-AP STA(s) at a designated wake-up time.

13. The apparatus of claim 12, wherein said designated wake-up time is received from a different link with a cross-link signal.

14. The apparatus of claim 10, wherein U-APSD and S-APSD operations can coexist.

15. The apparatus of claim 10, wherein explicit TWT operations are extended to operate in a broadcast TWT mode, toward increasing flexibility in having a broadcast TWT SP between two subsequent negotiated broadcast TWT SPs.

16. The apparatus of claim 10, wherein the suspending and resuming of both individual and broadcast TWT for all member STAs improves network efficiency.

17. The apparatus of claim 10, further comprising a dynamic transmission-identifier-to-link mapping (TTLM) which provides cross-link power management to provide power savings on over multiple links.

18. A method of performing multiple link device communications in a wireless network while providing dynamic power saving (PS), comprising:
(a) communicating between STAs of multiple link devices (MLDs) on an IEEE 802.11 wireless local area network (WLAN), with each of said MLDs comprising multiple stations (STAs) which are either access point (AP) STAs or non-AP STAs performing steps of a wireless communications protocol;
(b) wherein said STA, and the other STAs of the MLD, can be in either a dozing state or in an active state;
(c) wherein said active state comprises both a fully powered state in which it can transmit and/or receive in a higher powered active state or higher power active mode, and a lower powered active state or lower power active mode, in which it is capable of only listening; and
(d) wherein a cross-link signal is sent by said STA through an active link(s) to perform operations on at least one specific link(s) to wakeup a dozing AP or non-AP STA, or to put an active AP or non-AP STA into dozing mode, and suspend and resume target wait time (TWT) agreements and schedules for select TWT members or all TWT member STAs.

19. The method of claim 18, wherein if said STA is operating as an AP STA, then it is configured for performing automatic power save delivery (APSD) including performing unscheduled-APSD (U-APSD) and scheduled-APSD (S-APSD), over one or multiple links or sub-channels.

20. The method of claim 19, wherein the AP is enabled to process U-APSD based PS and to wake up to receive buffered units from its associated non-AP STA(s) at a designated wake-up time.
